(19) United States
(12) Patent Application Publication
(10) Pub. No.: US 2026/0370500 A1
(43) Pub. Date: Nov. 19, 2026

(54) SYSTEM AND METHOD FOR INTERFACING APPLICATIONS WITH BLOCKCHAIN NETWORKS

(71) Applicant: R-Squared Labs LLC, Miami, FL (US)

(72) Inventor: Robert Rosenthal, Miami, FL (US)

(73) Assignee: R-Squared Labs LLC, Miami, FL (US)

(21) Appl. No.: 19/675,343

(22) Filed: May 12, 2026

Related U.S. Application Data
(60) Provisional application No. 63/805,275, filed on May 13, 2025.
(60) Provisional application No. 63/989,554, filed on Feb. 24, 2026.

(51) Int. Cl. H04L 9/00; G06Q 20/38; H04L 9/08

(52) U.S. Cl. CPC H04L 9/50; G06Q 20/381; G06Q 20/38215; H04L 9/088

(57) ABSTRACT

The present invention provides systems and methods for interfacing a host software application with a blockchain network to conduct a blockchain transaction initiated through the host application, which includes binding a user's application identity with a user's blockchain account. Action data representing a user action triggered in the host application during an authenticated session and including authorization data for the user's access to the application is generated and received. The system converts the action data into blockchain intent payload data compatible with the blockchain network and representing a transaction to be performed on the blockchain network. The blockchain intent payload data is then sent to a sponsor wallet service on the blockchain network for execution of the transaction with payment for the user's transaction being made by the sponsor wallet service. Response data is received from the blockchain network representing a status of the execution of the transaction on the blockchain network, and the response data may be transmitted to the host application, such as in a message summarizing same, for use by the host application in responding to the user action.

### CROSS REFERENCE TO RELATED APPLICATIONS

This application claims priority to the following provisional patent applications, which are each hereby incorporated by reference herein in its entirety:
U.S. Provisional Patent Application Ser. No. 63/805,275, entitled “SYSTEMS AND METHODS TO PERMIT A DECENTRALIZED DIGITAL TOKEN EXCHANGE EMBEDDED DIRECTLY WITHIN A BLOCKCHAIN TO OPERATE BY WAY OF A SPONSOR WHO IS ABLE TO MANUFACTURE A DIGITAL TOKEN AND IS ABLE TO PAY FOR BLOCKCHAIN TRANSACTIONS ON BEHALF OF HOLDERS OF ANY DIGITAL TOKENS THEY MANUFACTURE BY USING THE BLOCKCHAIN NATIVE TOKEN AND IS RECOMPENSATED FOR SUCH PAYMENT IN MANUFACTURED TOKENS BY WAY OF AN AUTOMATED ASSESSMENT OF AN EXCHANGE RATE WHICH INCLUDES A REGISTRATION SERVICE TO PARTICIPATE,” filed May 13, 2025; and
U.S. Provisional Patent Application Ser. No. 63/989,554, entitled “SYSTEMS AND METHODS TO USE BLOCKCHAIN TECHNOLOGY TO ATOMICALLY SWAP ACCESS TO DATA RESIDING OFF-CHAIN IN RETURN FOR DIGITAL ASSETS WHERE SUCH SWAP TRANSACTIONS OCCUR UPON A SINGLE BLOCKCHAIN,” filed Feb. 24, 2026.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTIONS

### Field of the Inventions

This application generally relates to computerized systems for conducting transactions on blockchain networks, and in particular to systems for facilitating registration and binding of an application to a blockchain network to allow it to interface with and conduct transactions on the blockchain network.

### Description of the Related Art

Blockchain networks are decentralized, distributed ledger systems that record data transactions cryptographically confirmed by a trustless network of computers, each often referred to as a blockchain validator or block producer. Transactions are grouped into blocks of data linked to form immutable chains of data transactions. Blockchains allow participants to verify and record transactions without relying on a central authority to manage the transactions and data. Blockchains have become used for a variety of transactions, most notably cryptocurrencies, but also for real-world practical purposes such as the transfer of hospital and real estate records, digital ID management and voting systems. However, several issues or shortcomings with existing blockchain networks limit their utility for many real-world practical uses.

For example, to use blockchain networks, users must be aware that there is a specific format for each blockchain network and that they, the user, must acquire and store tokens native to the blockchain and know how to do that. Transaction formats vary across blockchain networks, and the addresses and keys native to blockchain networks are often specific to each network, especially with respect to blockchains that have different technical standards, for example Bitcoin and Ethereum, with each using its own distinct token for transaction payments. Products fail to integrate blockchain actions into normal user activity because transaction fees introduce a hard dependency on user funding and technical fluency alongside added costs. Users of applications who wish to practically share data generated on or through the application or otherwise take application actions or make application requests using a blockchain network must first have such actions or requests downloaded or reproduced and translated into the proper format for broadcasting into the blockchain where fees must be paid for the transactions to occur, with many desired outcomes needing either many number of transactions or large amounts of computational resources or both, resulting in a potentially challenging cost burden.

Another issue is financial governance. Sponsored blockchain payment programs can become significant cost centers, and operators do not readily understand where costs are generated, how to risk-manage value volatility of a token native to a blockchain, which workflows drive chain spend, and how sponsorship impacts activation, conversion, retention, or service quality. Sponsorship often becomes an opaque and risky enterprise.

Additionally, in order to allow practical use of the overall system by applications, these applications must be able to have a steady place to acquire the tokens needed to pay for blockchain transactions. Relying on external exchanges to acquire tokens needed to run an application risks withdrawal delays or random account freezes or exchange collapses. Such events would cause an application to fail if such application can't get their tokens in the required format to pay for their blockchain transactions—and moreover, from a practical perspective, it would render such a system too risky for an application to connect to and use.

As a further limitation, existing blockchains allow data sharing for data that is placed on-chain. Data being shared or transferred is thus exposed on the blockchain and only as secure as the blockchain itself. In addition, storing large files directly onto a blockchain is problematic from a performance standpoint, since blockchains, due to their distributed and decentralized nature, are more suited for smaller data transactions. An application that provides true data sovereignty should allow users to encrypt their data, store them in secure locations, and fully control who has permission to access such secure, encrypted data.

As a result, improvements are needed to allow for expanded usage of blockchain networks for data sovereignty and other applications.

### SUMMARY OF THE INVENTIONS

Some or all the above problems are solved by methods and systems of the present inventions that interface between software applications and blockchain networks. One objective of aspects of the present invention is to make blockchain-backed functionality available inside ordinary application experiences without requiring end users of the application to pre-fund blockchain wallets, manage fee assets, or understand blockchain-level payment internals during their interactions. The architecture is domain-neutral and usable with a wide variety of software applications; a healthcare records platform, legal workflow system, logistics network, education portal, supply chain dashboard, fintech product, enterprise collaboration or any other domain can apply the same architecture, albeit with policy and compliance adaptations which are supported by embodiments of the present inventions as described herein. The inventions thus provide a new architecture for, among other things, funding and transaction payment mechanics where a host application can pay blockchain transaction costs on behalf of its users.

Others of the above problems are solved by methods and systems of the present inventions that allow any application, company, organization or developer to provide immutable ownership over the access to any data, residing anywhere, to the actual data owner, and for that data owner to be able to directly share that information with anyone else of their choosing across the entirety of the internet. The new methods and systems thus bridge individual ownership over access to information, regardless of where it is stored or by whom, and regardless of file sizes, or number of files, with universal accessibility of all of that information across the entire internet, allowing everyone to own and control access to their data regardless of where it's stored, and to share it as they see fit.

Aspects of the present inventions facilitate the funding workflows that enable applications to cover blockchain transaction costs associated with data sovereignty operations, which allows the application to be able to utilize the data sovereignty backend. In addition, aspects of the present inventions provide a registration service that allows applications to register application users with accounts in the blockchain network and a binding service that facilitates binding between an application's native log in/sign up and blockchain registrations.

Further aspects of the present invention include the interaction between a decentralized exchange (DEX) inherent within existing blockchains, which include order placement, matching, and settlement, with an External Rate Service (ERS) which generates exchange rate updates following price change events used in exchanging a non-native-token issued to the application for native blockchain tokens used in blockchain transactions. The ERS performs a method to adjust the exchange rate between a new token issued and the native token based upon price fluctuations when comparing the two tokens. For example, consider a DEX trade where one native token is sold for 2 issued tokens, but in an active market, second by second, such a price can fluctuate up or down on an ongoing basis. It's vital to allow someone brand new to the system, with no native tokens, to acquire the native token with the issued token (which itself carries a transaction cost that needs to be paid with native tokens), and/or be able to use the issued token itself to pay for their blockchain transactions (wherein someone has to pay for those blockchain transactions in native tokens as well). In such cases, the issuer pays for the blockchain transaction (using native tokens that they already have), in return for which they are recompensed in issued tokens at an exchange rate set by the issuer allowing them to purchase more native tokens to refill their supply of native tokens as needed and/or simply to be recompensed for the loss of their native tokens. The ERS systematically updates the amount of newly issued tokens they are paid by analyzing market price changes. The ERS prevents the issuer from otherwise running out of native tokens used to pay for blockchain transactions and not being paid enough issued tokens in return to be able to go to the marketplace and purchase more native tokens. In effect if such a thing happened, the DEX itself could fail, and therefore the system would not be self-sufficient for application developers to have a steady place to acquire the tokens needed to operate their application.

In some aspects, the present inventions provide a method for interfacing a host software application with a blockchain network to conduct a blockchain transaction initiated through the host application. The method is performed by a processor executing computer program code contained in one or more software modules stored on one or more computer readable memory devices. In some embodiments, the method includes receiving action data representing a user action triggered in the host application during an authenticated session, the action data including authorization data for the user's access to the application. The method then involves converting the action data into blockchain intent payload data compatible with the blockchain network. In some embodiments, this is done by way of a reference table stored within the application's database that links certain of the host application's commands with certain specific blockchain operations each representing a transaction to be performed on the blockchain network. A sample action may be when one user wishes to permit another user to have access to their data. In this case, the corresponding intent payload would then be a blockchain operation to execute that permission. The blockchain intent payload data may then be sent to a sponsor wallet service on the blockchain network for execution of the transaction by way of further logic within the application such as “if user action (a) =true, then perform blockchain operation x using WebSocket Secure blockchain node connection (1).”

In some embodiments, the user may be permitted to pay for the blockchain transaction directly by way of a wallet established for them by a registration service operated by the host application. Response data is received from the blockchain network representing a status of the execution of the transaction on the blockchain network, and the response data may be transmitted to the host application, such as in a message summarizing same by way of an API, for use by the host application in responding to the user action.

In some embodiments, the method involves evaluating, using stored policy rule data accessed by a sponsorship policy engine, the blockchain intent payload data to determine eligibility for performance of the transaction in the blockchain network. The blockchain intent payload data is then sent to the sponsor wallet service only if the blockchain intent payload data is determined to be eligible. If the blockchain intent payload data is determined by the sponsorship policy engine not to be eligible for performance of the transaction in the blockchain network, a notice is sent to the host application that sponsorship is denied, preferably with detailed information on the basis for the ineligibility so the host application can try to correct the action and submit it again for evaluation.

In some embodiments, the action data comprises a user request to access data that the host application has encrypted and stored on a secure storage device or cloud service not part of the blockchain network. In such embodiments, the action data is converted by including in the blockchain intent payload data, among other things, a payment transaction to be made in the blockchain for access to the encrypted data. The response data transmitted may then include an authorization for the host application to decrypt the encrypted data and release the decrypted data to the user.

In some embodiments, the method includes binding the user's authenticated session on the host application with a blockchain related service, which may be in the form of a program, component, module, chip, firmware, or the like, that connects to and uses the blockchain network. The binding process may start by generating and sending to the blockchain related service a single-use nonce data value for the user's authenticated session, the nonce data value identifying the host application and user. The blockchain related service constructs binding payload data, which is signed using an on-chain private key and sends to a binding backend module the binding payload data linking the user's authenticated application session and the blockchain related service along with the public key associated with the private key that signed the payload. The binding backend module receives and records the binding payload data inclusive of the public key for use in verifying actions between the host application and blockchain related service. In some embodiments, recording the binding payload data involves verifying the nonce data value is unused and verifying the signed transaction and that the public key is valid for the account, and, if these verifications pass, returning an application token, such as a JSON Web Token, for use in API calls between the host application and blockchain related service.

When execution of the transaction includes making a payment using a first amount of one or more tokens native to the blockchain network or fraction thereof, which is needed, for example, for a blockchain account that has no native tokens and wishes to use the DEX to acquire them and can't pay for that transaction, the method may further include the blockchain network issuing one or more new, non-native tokens (or fraction thereof) to in effect pay for that transaction. An External Rate Service (ERS) module computes an adjustable exchange rate to account for volatility by consuming real-time and historical market data such as current price, trade history, numbers of trades, timing of trades, trade size, order history or other available market data by querying a blockchain node via API and employing an algorithm within the module to determine an exchange rate, for example a Volume Weighted Average Price (VWAP) algorithm, where VWAP=Σ(Price*volume)/Σ Volume. Programming logic may be written for the ERS module to where if, for example, in any 1 minute, 5 or more trades are executed, an exchange rate will be computed using VWAP and the exchange rate will then update by way of a blockchain operation using a WebSocket Secure blockchain node connection. This adjustable exchange rate is used to determine an amount of the new tokens needed to cover the cost of the actual transaction involving a first amount of native tokens or fraction thereof and the determined amount of the new tokens or fraction thereof is exchanged for the amount of native tokens or fraction thereof used for the actual payment. Some embodiments may involve ongoing exchange rate adjustments to account for a preference to pay for transactions in new tokens versus paying for them with native tokens.

In some embodiments, the method includes a process for automatically registering an account on the blockchain network for use by the application. The method involves receiving a request from the host application to create an account with the blockchain network, the request including account parameter data and registration data, constructing account creation transaction data in a format native to the blockchain network, the transaction data comprising a plurality of parameters such as account name and registrar identification, signing the account creation transaction data with credentials of the registrar, and broadcasting the signed transaction data to the blockchain network.

In accordance with some aspects of the present invention, a system is provided for interfacing a host software application with a blockchain network to conduct a blockchain transaction initiated through the host application. The system comprises a plurality of layers of software modules represented by computer program code stored on one or more memory devices and executed by one or more processors. The layers in the system include at least the following:
a host application interface layer configured to receive action data representing a user action triggered in the host application during an authenticated session, the action data including authorization data for the user's access to the application;
an intent builder layer configured to convert the action data into blockchain intent payload data compatible with the blockchain network and representing a transaction to be performed on the blockchain network;
a sponsorship policy layer configured to send the blockchain intent payload data to a sponsor wallet service on the blockchain network to pay for execution of the transaction on behalf of the user action or to permit the user to pay the transaction cost directly; and
a relay and orchestration layer configured to receive response data from the blockchain network representing a status of the execution of the transaction on the blockchain network and transmit the response data to the application for use in responding to the user action.

In some embodiments, the sponsorship policy layer is further configured to evaluate, using stored policy rule data, the blockchain intent payload data to determine eligibility for performance of the transaction in the blockchain network, send the blockchain intent payload data to the sponsor wallet service if the blockchain intent payload data is determined to be eligible, and notify the host application that sponsorship is denied if the blockchain intent payload data is determined not to be eligible for performance of the transaction in the blockchain network. In some embodiments the user may be permitted to pay for the transaction directly, in which case the blockchain intent payload data may be sent directly to the user's blockchain account.

The system may further include a binding layer configured to bind the user's authenticated session on the host application with the sponsor wallet service. The binding layer first generates and sends to the sponsor wallet service a single-use nonce data value for the user's authenticated session, the nonce data value comprising data identifying the host application and user. It then receives from the sponsor wallet service binding payload data generated using the data it sent and linking the user's authenticated application session and the sponsor wallet service. The binding payload data is cryptographically signed by the user using a private key. The binding layer further receives a public key associated with the private key. It then records the binding payload data (inclusive of the public key) for use in verifying actions between the host application and sponsor wallet service. In some embodiments, the binding layer is configured to record the binding payload data by verifying the nonce data value is unused, verifying the signature value and public key, and, if both verifications pass, returning an application token, such as a JSON Web Token, for use in API calls between the host application and sponsor wallet service.

In some embodiments which support a data sovereignty service as explained above, the system's intent builder layer is configured to convert the action data by including in the blockchain intent payload data a payment transaction to be made in the blockchain for access to encrypted data that the host application has encrypted and stored on a secure storage device or cloud service not part of the blockchain network, access to which was requested through the action data. The execution of the transaction may include making a payment using a first amount of one or more tokens native to the blockchain network which the payor may not have. In some embodiments, an External Rate Service module is included in the system which is configured to compute an adjustable exchange rate based on real-time and historical market data and determine, using the computed adjustable exchange rate, an amount of one or more new tokens, or fraction thereof, needed to cover the cost of the actual transaction involving a first amount of native tokens or fraction thereof and the determined amount of the new tokens or fraction thereof is exchanged for the amount of native tokens or fraction thereof used for the actual payment, the one or more new tokens or fraction thereof having been issued by the blockchain network. In some embodiments, the issuance of new tokens may involve a preference to sponsor transaction payments on an ongoing basis in new tokens versus native tokens, or a preference by the user to pay for their transactions directly in new tokens versus native tokens on an ongoing basis.

In some embodiments the system further includes a service layer configured to create an account in the blockchain network for the host application. This may be done by first receiving a request from the host application to create an account with the blockchain network, the request including account parameter data and registration data. The service layer then constructs account creation transaction data in a format native to the blockchain network, the transaction data including a plurality of parameters such as account name and registrar identification. The service layer signs the account creation transaction data with credentials of the registrar and broadcasts the signed transaction data to the blockchain network, where it is used by a blockchain node to create an account on the blockchain network.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a system for interfacing between applications and blockchain networks, including applications, modules, etc. for making securely stored data available to application users, according to embodiments of the present invention;

FIG. 2 illustrates certain software layers within the application-blockchain interface according to embodiments of the present invention;

FIG. 3 contains a flowchart of a method for interfacing between applications and blockchain networks according to embodiments of the present invention;

FIG. 4 contains a data flow diagram illustrating the flow of data within the system components and layers of FIGS. 1 and 2 during performance of a method of interfacing between an application and a blockchain network according to embodiments of the present invention;

FIG. 5 contains a flowchart of a method for making secure data stored off-chain available to application users through blockchain transactions according to embodiments of the present invention;

FIG. 5A contains a data flow diagram illustrating the flow of data between system components during performance of a method for making secure data stored off-chain available to application users through blockchain transactions according to embodiments of the present invention;

FIG. 5B contains a flowchart of a method for controlling plug-in use and selection according to embodiments of the present invention;

FIG. 5C contains a flow chart of a method for tuning node parameters according to embodiments of the present invention;

FIG. 6 contains a flowchart of a method for registering a blockchain account for a particular application according to embodiments of the present invention;

FIG. 6A contains a data flow diagram illustrating the flow of data between system components during performance of a method for registering a blockchain account for a particular application according to embodiments of the present invention;

FIGS. 7 and 7A contain flowcharts of methods for binding an application session with a blockchain network according to embodiments of the present invention;

FIG. 7B contains a data flow diagram illustrating the flow of data between system components during performance of a method for binding an application session with a blockchain network for a new blockchain account according to embodiments of the present invention;

FIG. 7C contains a data flow diagram illustrating the flow of data between system components during performance of a method for binding an application session with a blockchain network for a new blockchain account according to embodiments of the present invention;

FIG. 7D contains a data flow diagram illustrating the flow of data between system components during performance of a method for binding an application session with a blockchain network for an existing blockchain account according to embodiments of the present invention;

FIG. 8 contains a flowchart of a method for computing adjustable exchange rates for the exchange of new blockchain tokens in return for the payment of blockchain transactions in native tokens to facilitate transactions performed though applications according to embodiments of the present invention; and

FIG. 8A contains a data flow diagram illustrating the flow of data between system components during performance of a method for computing adjustable exchange rates for the exchange of new blockchain tokens in return for the payment of blockchain transactions in native tokens to facilitate transactions performed though applications according to embodiments of the present invention.

### DETAILED DESCRIPTION OF THE INVENTIONS

Subject matter will now be described more fully hereinafter with reference to the accompanying drawings, which form a part hereof, and which show, by way of illustration, exemplary embodiments in which the inventions may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present inventions. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

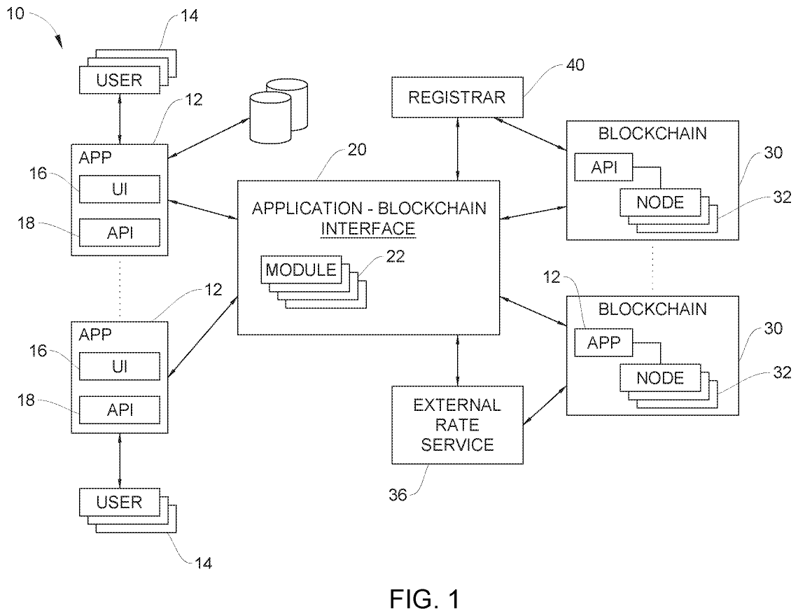

The present inventions provide methods and systems for interfacing software applications with blockchain networks. With reference to FIG. 1, the overall system 10 includes one or more software applications or apps 12 installed and/or executing on user devices 14 such as computers, laptops, smartphones or other personal devices. The applications 12 include both user interface components 16 through which users 14 interact with the applications 12 and application program interfaces (APIs) 18 through which applications 12 communicate and share data with other devices, applications, modules, etc. An application-blockchain interface system 20 is provided which is communicatively coupled to the applications 12 such as over the Internet or other network such as a local network and includes a series of software modules, layers, routines, or components 22, some of which receive data and commands from, and send data and commands to, the applications 12.

The application-blockchain interface system 20 is also communicatively coupled to one or more blockchain networks 30 such as over the Internet or other network. Nodes 32 are used to send transactions directly into the blockchain network 30 for validation and execution through APIs which also allow the node 32 to communicate and share data with other systems such as the application-blockchain interface system 20. Nodes in this system may be distinguished based on targeted plug-ins. Block producing nodes for example may be different from application (development) nodes, where applications may use certain application node plug-ins for their targeted purposes. This allows for flexibility when it comes to managing memory costs. For example, some applications may require less memory resources than being a block producer. In most blockchains, if you're a node you're a node. Herein there are, in effect, different types of nodes. Thus, herein, a blockchain network generally refers to a trustless network of block producers, and a node generally refers to the mechanism by which applications 12 broadcast transactions directly into the blockchain network for validation and execution for their purposes.

As described in detail herein, the software modules or layers 22 perform a variety of functions needed to receive actions taken by users 14 in the applications 12, convert them into transactions that can be performed on a blockchain network 30, broadcast the transactions on the blockchain network 30, receive and monitor the progress and results of the transactions through the blockchain network 30, and report the results to the application 12. The modules 22 also facilitate account registration on the blockchain networks 30 for the applications 12, including through access to a registrar system 40, as explained further below. The system 10 also includes an External Rate Service (ERS) module 36 which computes adjustable blockchain token exchange rates as described further below and which may be part of the application-blockchain interface 20, in a blockchain network 30, or provided on a separate computer accessible to the blockchain network 30.

The system 10 represents a new architecture for funding and transaction payment mechanics where a host application 12 can pay blockchain transaction costs on behalf of its users. This architecture makes blockchain-backed functionality available inside ordinary application experiences without requiring end users to pre-fund wallets, manage fee assets, or understand chain-level payment internals during their interactions. The model is domain-neutral; a healthcare records platform, legal workflow system, logistics network, education portal, supply chain dashboard, fintech product, enterprise collaboration or any other domain can apply the same architecture pattern with only policy and compliance adaptations.

The architecture of the system 10 separates user identity and business authorization from fee sponsorship execution. Users 14 still sign up and log in through the native identity models of applications 12, while the application-blockchain interface 20 manages sponsored transaction execution through dedicated sponsorship services and controlled signing infrastructure. In practical terms, users 14 trigger business actions through use of the applications 12, the application-blockchain interface 20 converts those actions into canonical blockchain intents, and a policy-governed sponsor path determines whether the blockchain network 30 receives the fee for the transaction lifecycle. Blockchain sponsorship is not a blanket bypass of trust controls; it is a governed privilege with explicit boundaries, budget controls, risk checks, and auditable decision trails. As explained further herein, every sponsored action is designed to be attributable to an authenticated app context, a policy decision, and an immutable transaction trace. This transforms fee payment from a user burden into an operator-managed service capability while preserving accountability, traceability, and security posture.

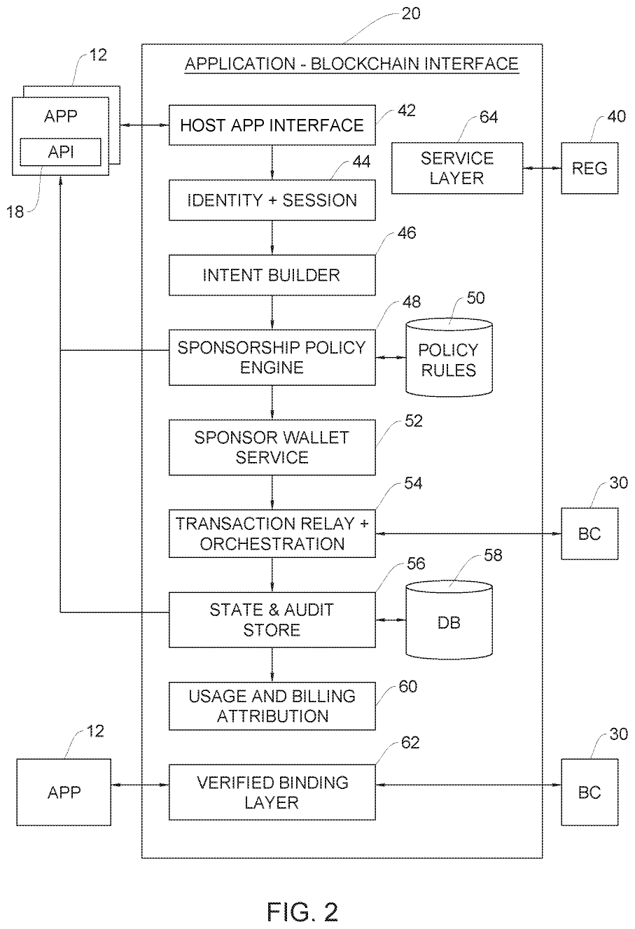

Embodiments of the modules 22 contained within application-blockchain interface system 20 are shown in FIG. 2. The architecture of the interface system 20 is composed of coordinated software layers that each hold a clear responsibility in the sponsored transaction lifecycle. A host application interface 42 captures user action data and application authentication data received from applications 12. The user action data represents an action requested by the user through the application 12, such as to retrieve data which has been encrypted and securely stored off-chain, as described further below. An identity and session layer 44 receives the application authentication data from the host application interface and validates that the user action request originates from a legitimate app session and authorized user profile. Assuming the identity and session layer 44 validates the authentication data and user action request, an intent builder layer 46 receives the user action data and transforms it into standardized and canonical blockchain intent payload data with deterministic structure and idempotency keys, such as Universally Unique Identifiers, by way of, for example, a reference table stored within the application's database that links selected ones of the host application commands with specific blockchain operations each representing a transaction to be performed on the blockchain network. A sample action may be when one user wishes to permit another user to have access to their data. In this case, the corresponding intent payload would then be a blockchain operation to execute that permission. The blockchain intent payload data may then be sent to a sponsor wallet service on the blockchain network for execution of the transaction by way of further logic within the application such as “if user action (a)=true, then perform blockchain operation x using WebSocket Secure blockchain node connection (1).” In some embodiments, the user may be permitted to pay for the blockchain transaction directly by way of a wallet established for them by a registration service operated by the host application. Response data is received from the blockchain network representing a status of the execution of the transaction on the blockchain network, and the response data may be transmitted to the host application, such as in a message summarizing same by way of an API for use by the host application in responding to the user action. Canonicalization ensures that policy decisions, signatures, and audit records all refer to the same normalized payload representation.

A sponsorship policy engine layer 48 receives the blockchain intent payload data and evaluates its eligibility as a transaction on the blockchain using stored policy rules 50 that may include operation type, risk posture, user trust level, tenant configuration, consumption quotas, and sponsor budget thresholds. Deterministic rules can be applied based upon the host application's requirements (for example, “if policy (1) and policy (2)=true, then trigger sponsor wallet service to perform blockchain operation x.”). If the sponsorship policy engine layer 48 determines the blockchain intent payload data to be ineligible, it may send a message back to the application 12 through the API 18, a standard backend communication method such as an API or message broker within the application 12, or both, indicating that the user action was rejected and providing data with necessary details for the application 12 or user to redo the action. The sponsorship policy engine 48 thus evaluates whether sponsorship is allowed, denied, or perhaps escalated, or deferred, etc., depending upon the desired engine logic—with outcomes such as escalation and deferment then subject to further login in the application 12. If sponsorship is denied, the interface system 20 supports controlled alternatives, such as user-paid execution, in which further logic can be implemented to allow a user to pay for a blockchain transaction from their own wallet using their funds, delayed retries, or operator intervention routes.

Assuming the sponsorship policy engine layer 48 determines the blockchain intent payload data is eligible, a sponsor wallet service 52 executes controlled signing or transaction preparation of a blockchain operation for sponsored payment using constrained key pathways once sponsorship is approved. The operation may either be performed as a sponsored transaction, similar to the registration operation that allows a registrar to pay the fee for account registration for a new user, in that in both instances the sponsor's wallet signs the transaction using their keys. From there, the blockchain may perform the actual operation on behalf of the user passively, without the need for the user to sign another transaction, not unlike how the blockchain performs certain on-chain registration operations on behalf of a new user passively like the creation of an account record and storing the account name. Alternatively, the operation may be implemented as a sponsored payment where the user signs the transaction but the payment for the transaction is made by the host application, similar to when a CHP pays for a transaction on behalf of another user as described below, or by way of an HTLC sponsored payment as described below. Such new operations may be scripted using C++ and by referring to the aforementioned sponsored registration or CHP operations which are available open source at https://github.com/R-Squared-Project as a guide. This service should remain isolated, heavily monitored, and policy-bound to prevent unrestricted key usage. A transaction relay and orchestration layer 54 manages broadcasting, tracking, retries, and lifecycle transitions by coordinating with node interfaces in the blockchain 30 to submit operations and retrieve chain responses. The relay and orchestration layer 54 broadcasts approved blockchain intent payload data to the blockchain network 30. The relay and orchestration layer 54 tracks confirmations, failures, and timeouts.

A state and audit persistence layer 56 records data in a database 58 representing every meaningful stage, including request creation, policy decision, signature event, submission metadata, transaction hash correlation, confirmation updates, and terminal outcomes. The state and audit layer 56 records data reflecting requested, approved, submitted, pending, confirmed, rejected, or failed stages. These transitions are persisted and stored in database 58 with timestamps and correlation identifiers so that any outcome can be reconstructed for support, compliance, or forensic analysis. At this stage, following the successful completion of a blockchain operation by way of the sponsor wallet service, further logic may be implemented to send a message back to the application 12 through the API 18 providing data with necessary details for the application 12 or the user to perform further action if needed. A usage and billing attribution layer 60 converts these records into financial and operational views, enabling budget tracking, per-feature cost accounting, and governance analytics.

Beyond direct fee sponsorship, such a schema also allows a host application to perform their own blockchain transactions based on requests from their users without incurring undue or unexpected costs, such as permitting access to the host application's proprietary data under controlled conditions both at the intent builder layer and at the sponsorship layer, and provides the host application with flexibility when it comes to covering the transaction costs of its users by permitting the host application to fund a user's wallet under certain conditions to cover that user's blockchain transaction costs, thus allowing that user to perform blockchain operations such as permitting access to their data directly through their own wallet through the use of a Hashed TimeLock Contract (HTLC). The scripting, which may be in C++, allows both sides to transact on the same chain. Guidance is available open source at https://github.com/bitshares/bitshares-core/wiki/HTLC, to be applied to core logic available open source at https://github.com/R-Squared-Project/R-Squared-core, both of which are hereby incorporated by reference herein. This application of HTLCs is not to be applied to atomically swap one on-chain asset for another, which is the known application of HTLC with respect to blockchain networks. Instead HTLCs are applied herein to atomically swap a blockchain transaction which allows a user to share the access to their data by way of content_cards or personal_data as described herein in return for an on-chain asset, or vice versa.

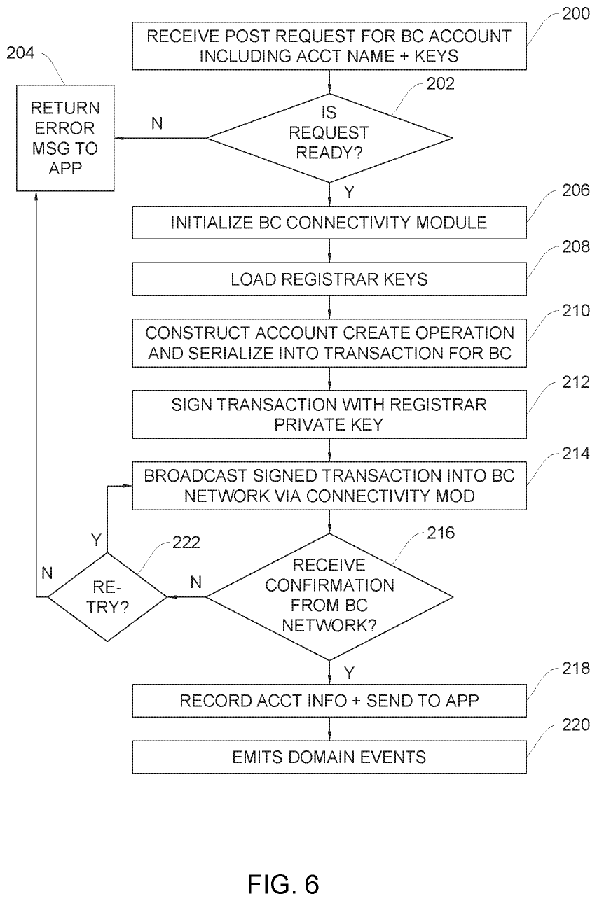

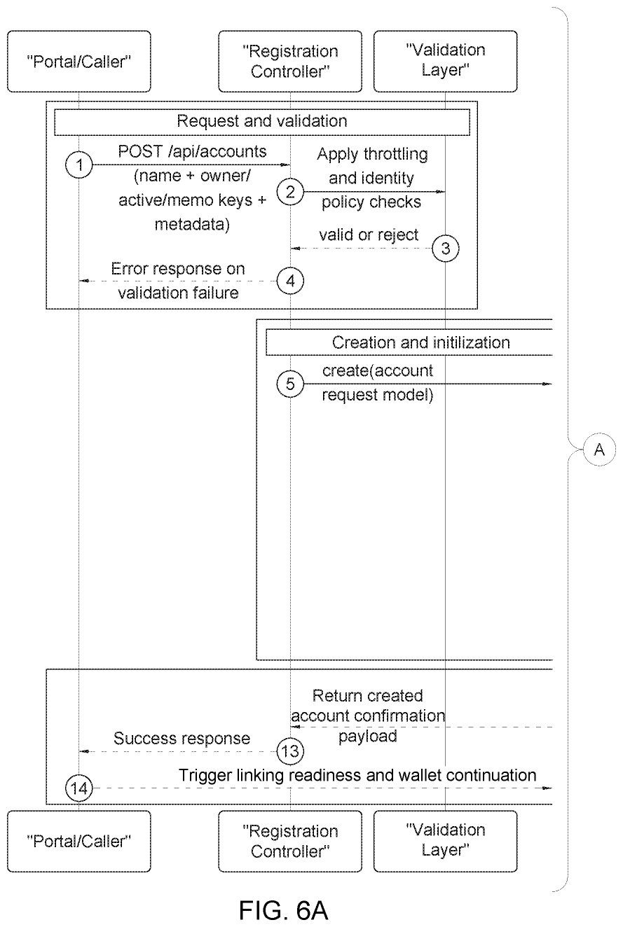

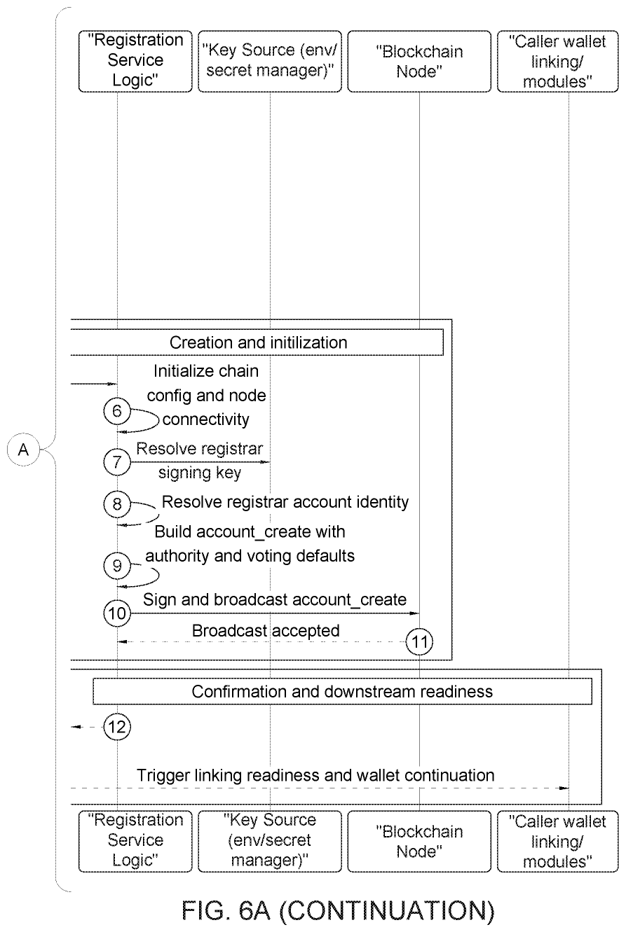

When using an HTLC, the user engages through the app's user interface 16 to create a random, secure preimage or secret, set a TimeLock expiry, and compute a hash of the preimage by way of a hashing algorithm such as SHA-256. The user then sends the hash through the network, locking the transaction that allows access to that user's data, and communicating with the blockchain network through a WebSocket Secure blockchain node connection. The user then shares the hash with the sponsor and sends a notification to the sponsor through the host application which may use a push notification service, an API-driven request or a service worker. From there prior to TimeLock expiry, the sponsor locks the funds using the same hash to cover the cost of the user's transaction, sets its own TimeLock expiry and sends a notification back to the user within the host application. The user then reveals the secret to claim the funds, which are claimed at the blockchain level, and the sponsor uses the revealed secret to send the user's transaction to the blockchain. If the sponsor's TimeLock expires, they are eligible for a refund and the user's transaction is effectively cancelled because it's never sent. If the user's TimeLock expires prior to the sponsor locking funds, then, again, the user's transaction is effectively cancelled because the transaction is never sent. As there is no intermediary, and the method occurs atomically in a self-executing manner, the host application may abstract the technical complexity and manual steps enabling ease of use for the user by way of full stack development using, for example, the MERN stack (MongoDB, Express.js, React.js, Node.js) for web development and/or MERN+React Native for mobile app development as a wrapper for the blockchain interactions, or by referencing or building upon front end open source available at https://github.com/R-Squared-Project/R-Squared-portal, which is hereby incorporated herein by reference. Such a schema also provides the host application with flexibility to apply adaptive sponsorship policies by user segment, feature type, feature frequency, compliance constraints, etc. A new user may receive full payment sponsorship for account registration as shown in FIG. 6, while a high-frequency user may receive throttled and therefore partial payment sponsorship for other blockchain operations.

The architecture of the application-blockchain interface system 20 thus follows a dual-authority pattern. The user authorizes business intent inside the app domain, while the host application authorizes fee payment inside the sponsorship domain. The user's action alone does not automatically imply sponsorship. Instead, each request is evaluated against policy rules before sponsor resources are consumed. This boundary helps prevent application actions from directly escalating into unrestricted fee-paid chain operations. This architecture does not depend on a specific business vertical; the same control loop applies whether the user is sharing a medical record, notarizing a document, approving a shipment event, or publishing a compliance artifact. The distinction lies in the policy rules and data governance, not in the sponsorship mechanics themselves.

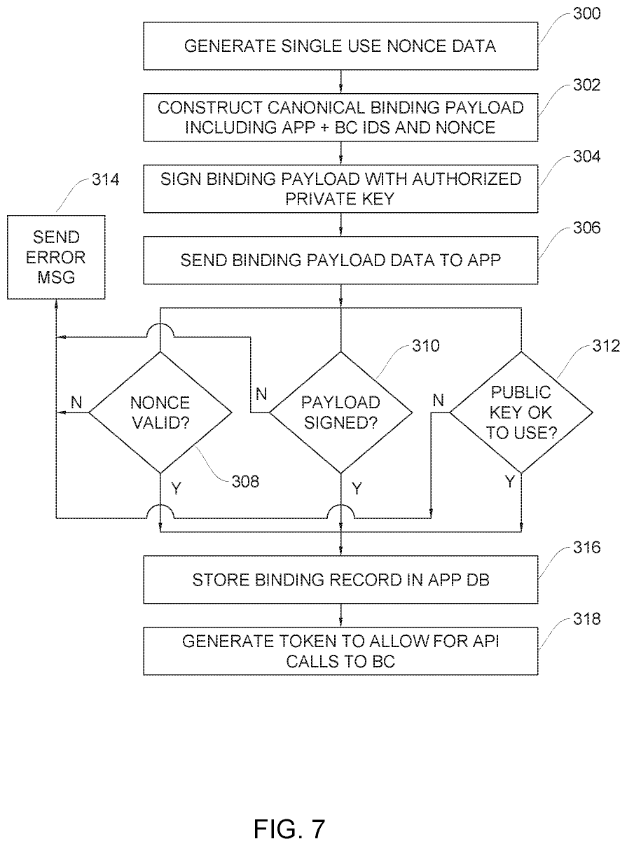

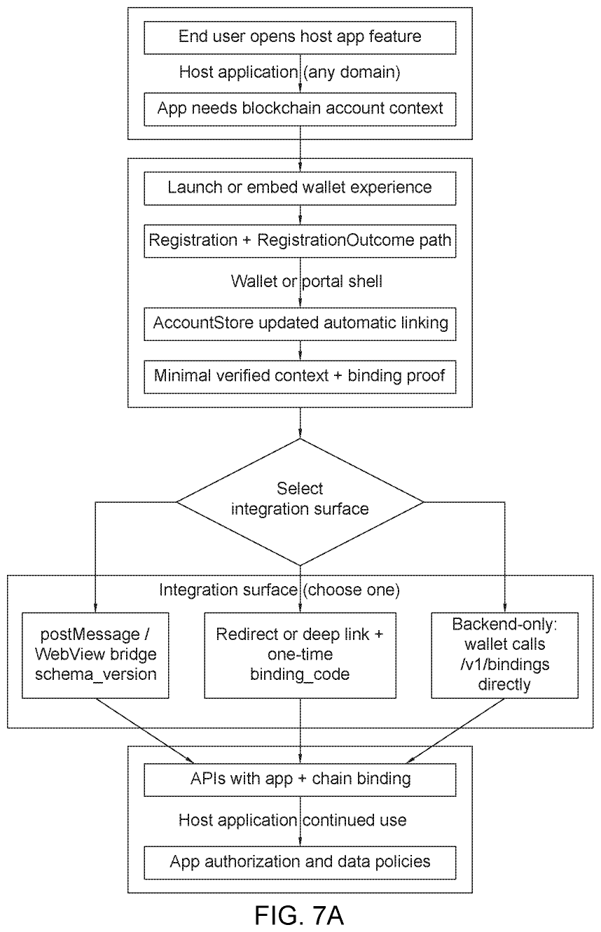

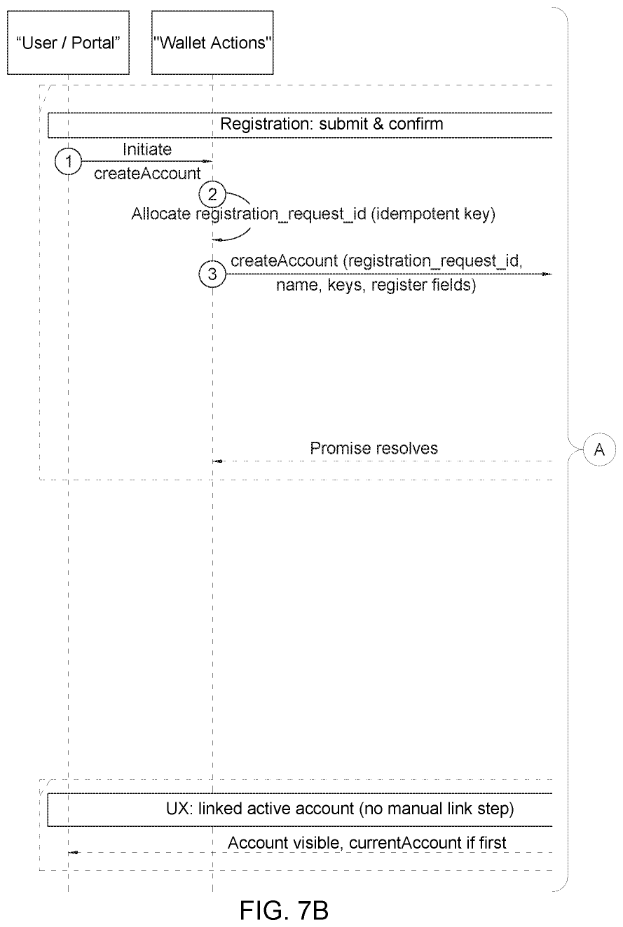

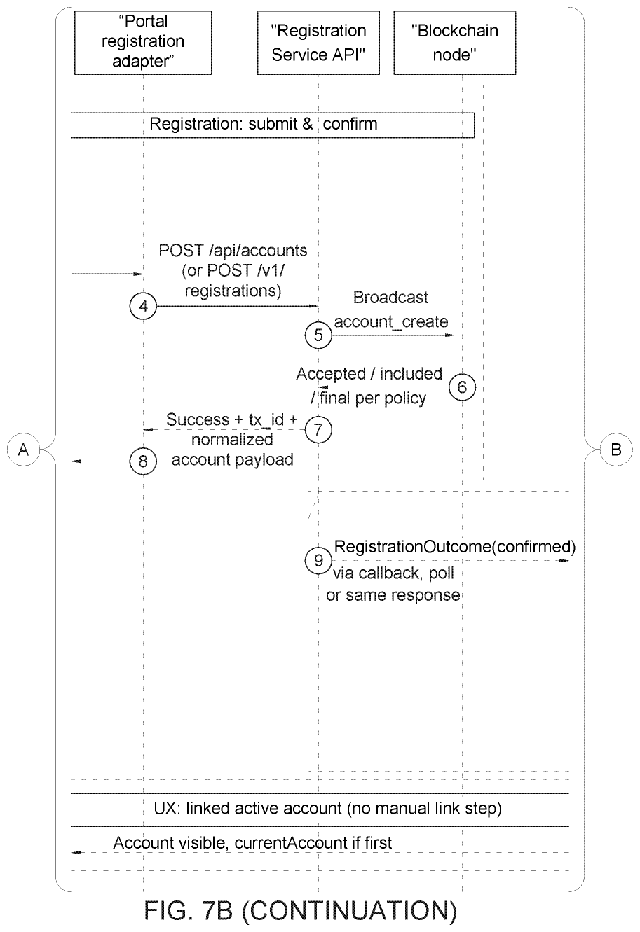

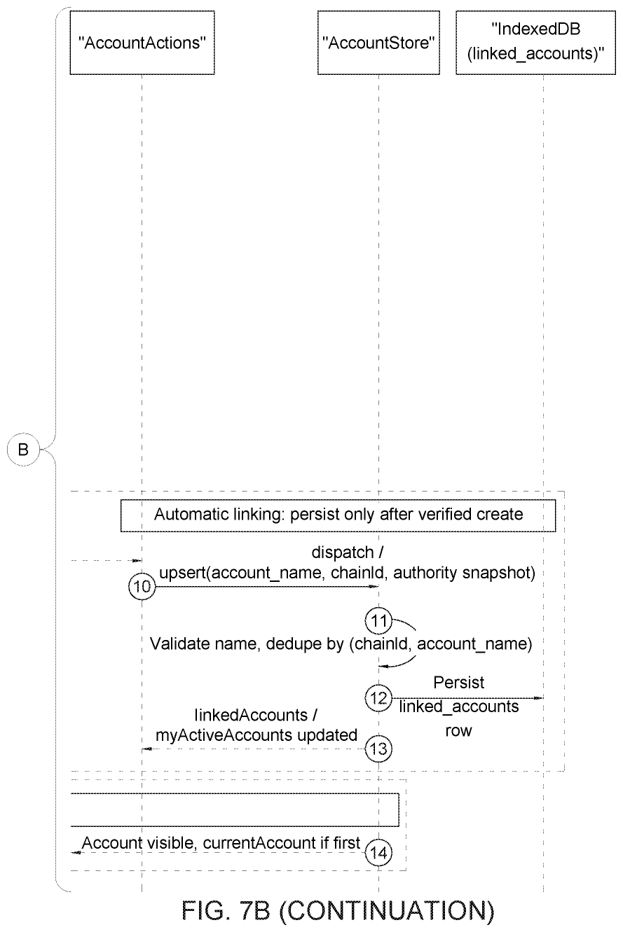

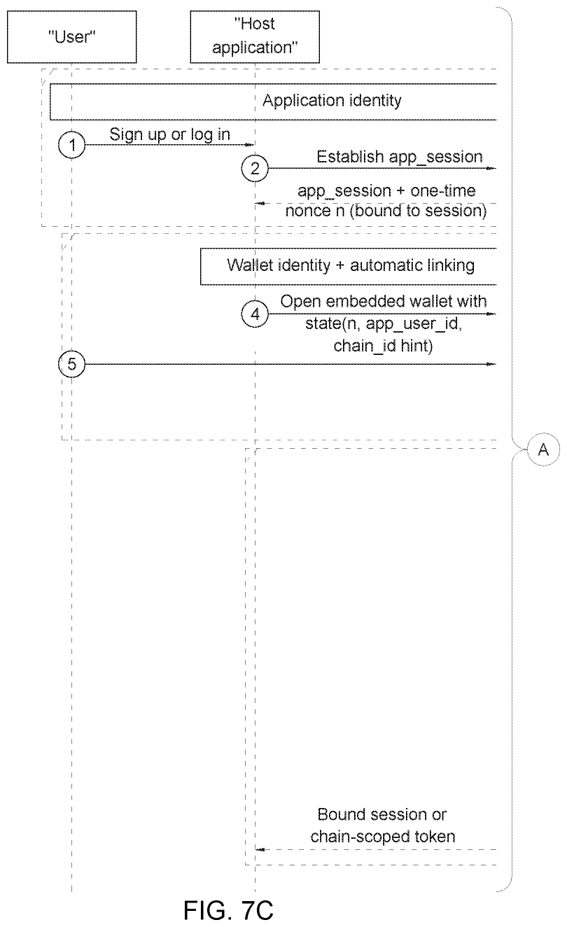

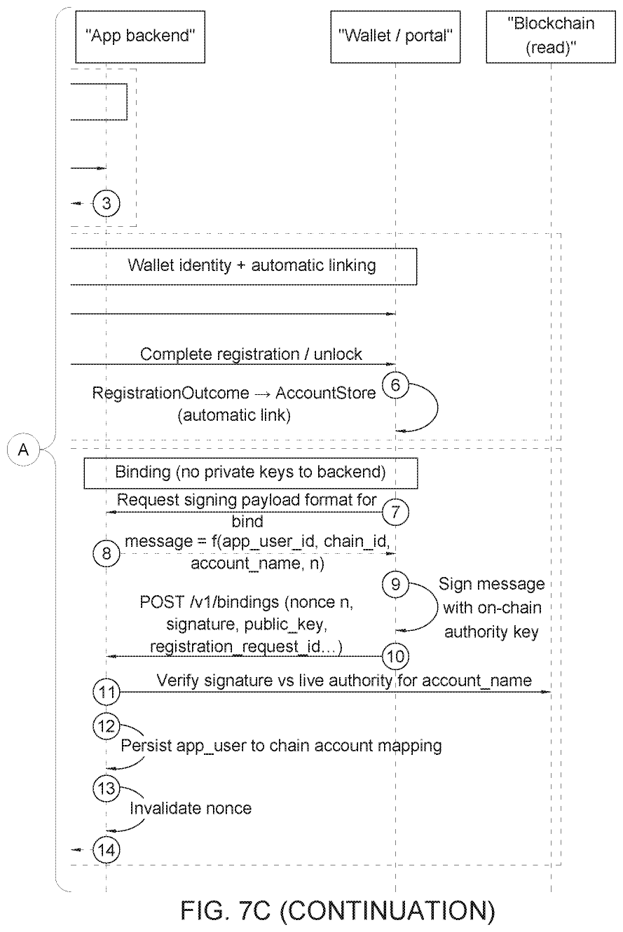

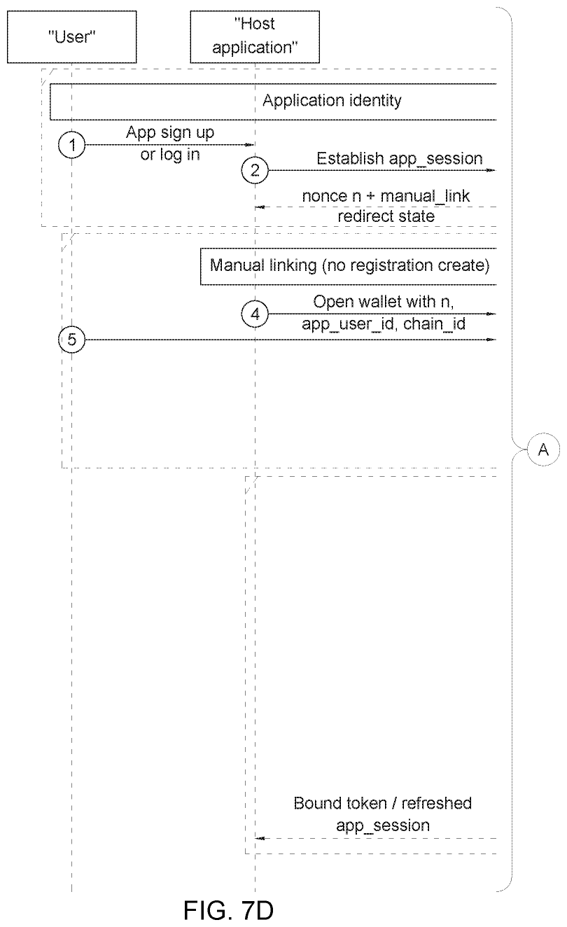

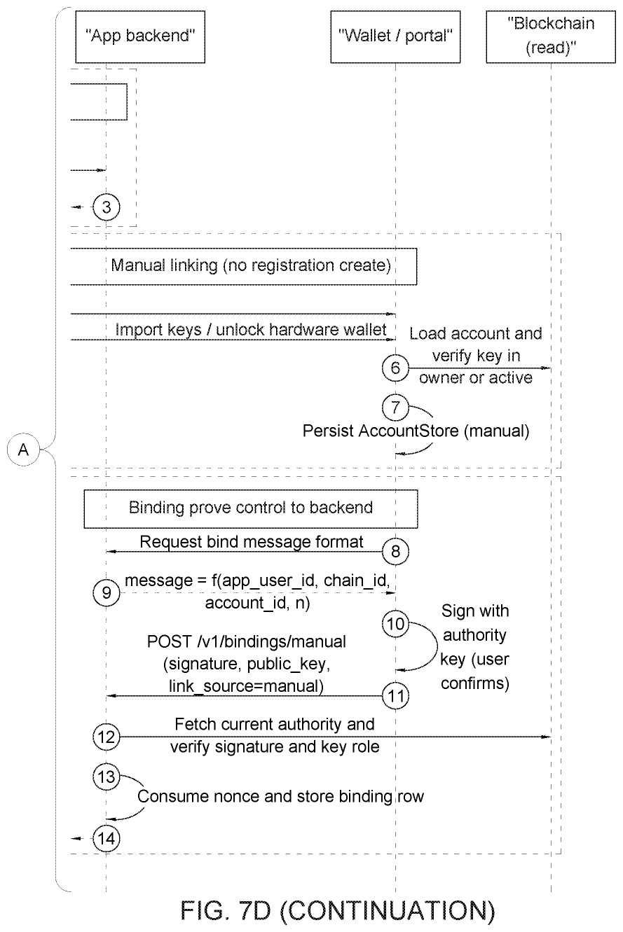

In some embodiments, the application-blockchain interface 20 includes additional layers to support additional functionality needed to connect applications 12 and blockchains 30. One such layer is a verified binding layer 62, which binds a session of an application 12 with a transaction in the blockchain 30, as described further below with respect to FIGS. 7-7D. Another such layer is a service layer 64 which registers an account on the blockchain network 30 for a particular application 12 using data form an outside registrar system 40, as described further below with references to FIGS. 6-6A.

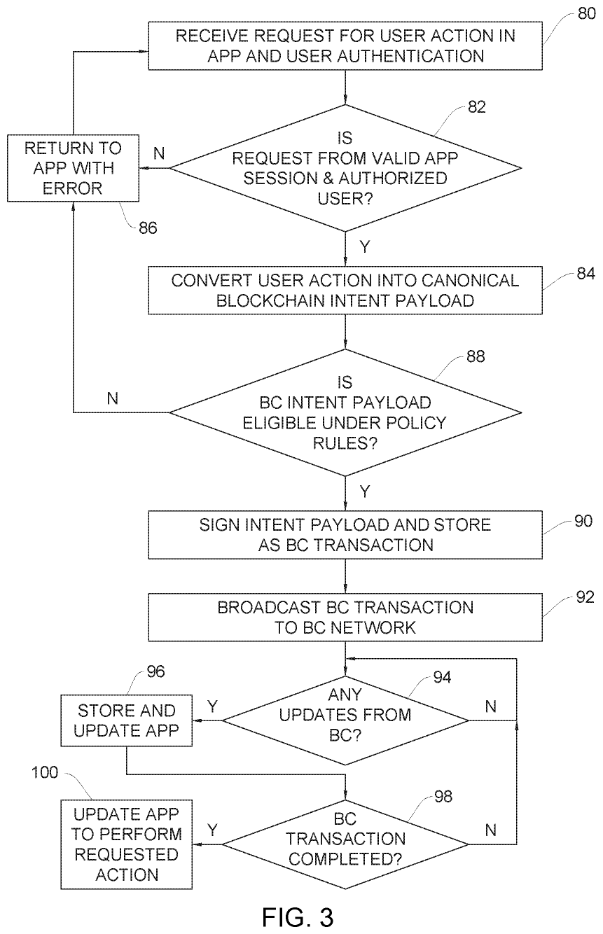

A method for interfacing between a host software application and blockchain network in accordance with embodiments of the inventions is shown in FIG. 3. This method may be performed using the systems and architecture illustrated in FIGS. 1 and 2 or may be performed in an alternative architecture as would be understood by one of skill in the art. The method begins with, at 80, receipt of a request to perform a user action in the application, where a user action is any action on the part of the user within the host application where, by tapping or clicking from the user interface, the user triggers the host application to perform an event-driven action by way of an event handler, e.g., by way of a piece of code that runs in response to the user action, which is part and parcel of standard event-driven application programming, along with user authentication data. This occurs after a user has signed up or logged in through the host application's standard identity path, such as Password-Based Authentication, OAuth 2.0 with OpenID Connect (OIDC), etc., and performed an action that requires on-chain persistence or verification. The request including the user authentication data is checked to confirm it is from a valid application session and that the user is authorized, 82. If the request is valid, the user action is converted into a canonical blockchain intent payload, 84, by way of, for example, a reference table stored within the application's database that ties certain of the host application commands with certain specific blockchain operations, representing a transaction to be performed on the blockchain network, such as a blockchain operation to allow one user to share the access to their data with another user. If the request is invalid or unauthenticated, a message is returned to the application with an indicated of the nature of the error, 86.

The converted blockchain intent payload is forwarded to the sponsorship pipeline by way of standard backend communication method such as API, message broker, etc., where it is evaluated against a set of stored policy rules to confirm it is eligible, 88. This evaluation includes checking a number of variables, including identity context, such as the specific user and whether or not they are functionally approved for a blockchain transaction type, and operation semantics, such as a sequence of operations requested through the blockchain intent payload. Deterministic rules can be applied here based upon the host application's requirements (for example, “if policy (1) and policy (2)=true, then trigger sponsor wallet service to perform blockchain operation x.”). When requests are denied as ineligible, 88, the system returns a denial outcome to the applications, 86, through an API from the blockchain, a standard backend communication method such as an API 18 or message broker within the application 12, or both, with explicit reason categories that can drive deterministic user messaging and product behavior. Some requests may be recoverable through retry paths, while others may require user-funded fallback or manual approval policies such as separate logic that permits the user to fund blockchain transactions directly from their own wallet using their funds.

When eligibility is confirmed at 88, the blockchain intent payload data is signed and stored as a blockchain transaction, 90. This may be performed by the sponsor wallet service 52, which executes controlled signing behavior and produces a sponsor-backed transaction envelope for broadcast. In some embodiments, the user may be permitted to pay for the blockchain transaction directly. The signed blockchain intent payload is then broadcast to the blockchain network, 92. This may be performed by the relay and orchestration layer 54, which submits the operation to the blockchain network, captures submission data, begins lifecycle tracking, monitors status transitions and propagates result updates back to application workflows so user-facing state in the host application remains consistent with chain execution reality. The operation is similar to the registration operation that allows a registrar to pay the fee for account registration for a new user in that it's the sponsor's wallet that signs the transaction. From there, the blockchain may perform the actual operation on behalf of the user passively (meaning without the need for the user to sign another transaction), not unlike how the blockchain performs certain on-chain registration operations on behalf of a new user passively like the creation of an account record and storing the account name. Alternatively, the operation may be implemented as a sponsored payment where the user signs the transaction but the payment for the transaction is made by the host application, similar to when a CHP pays for a transaction on behalf of another user as described below, or by way of an HTLC sponsored payment as described herein. Such new operations may be scripted using C++ and by referring to the aforementioned sponsored registration or CHP operations which are available open source at https://github.com/R-Squared-Project as a guide. As updates are received back from the blockchain by way of node 32 using known methods for monitoring such as an event listener, and known methods for ingestion and data management such as Extract, Transform, Load and post-load indexing, 94, they are stored and used to update the application, 96, by way of the full stack architecture of the app; for example, the MERN stack (MongoDB, Express.js, React.js, Node.js) for web development and/or MERN+React Native for mobile app development, inclusive of standard DevOps architecture which may also include services such as Amazon Web Service, etc. Once the transaction has been completed on the blockchain network, 98, the application is updated so that it may perform the user action originally requested, 100.

This algorithmic flow allows applications to integrate blockchain-backed actions in real time while maintaining policy discipline. Users experience continuity of application behavior, while blockchain operators retain explicit control over fee exposure.

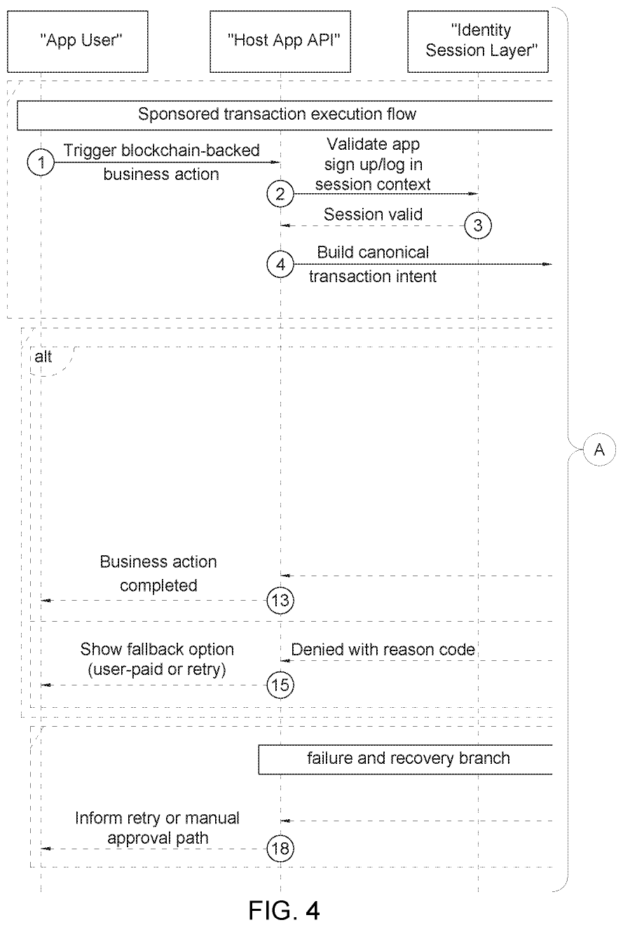

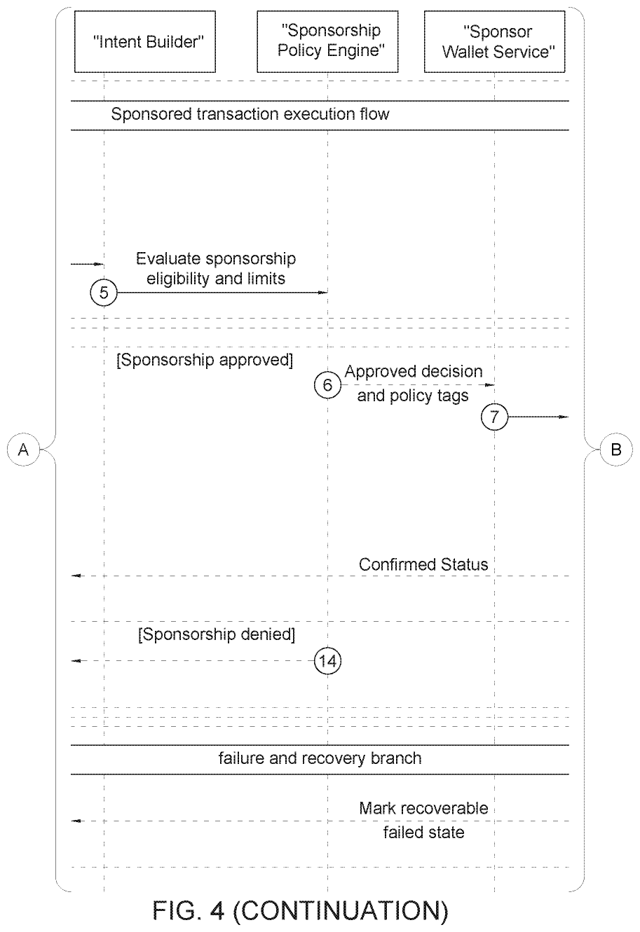

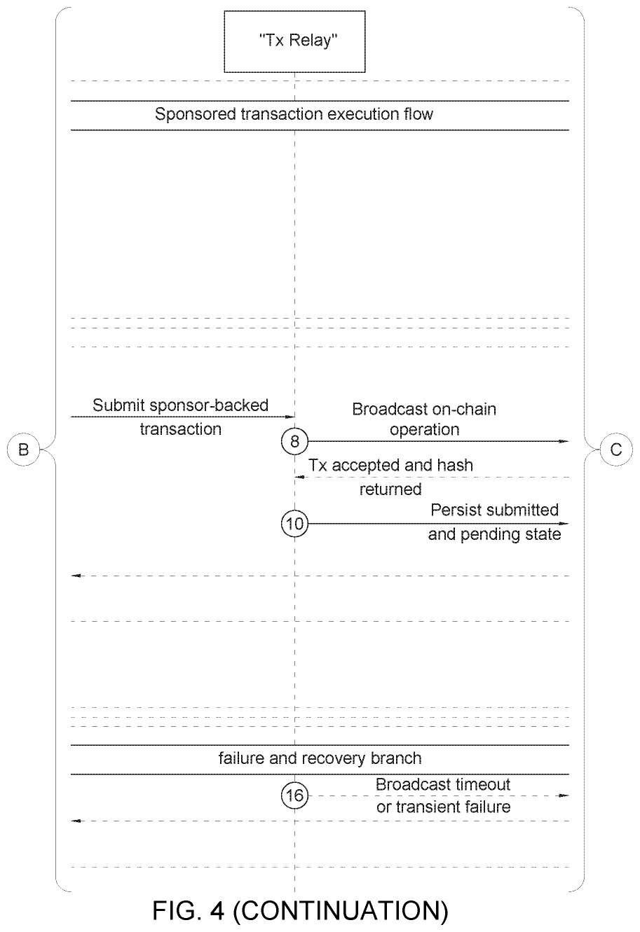

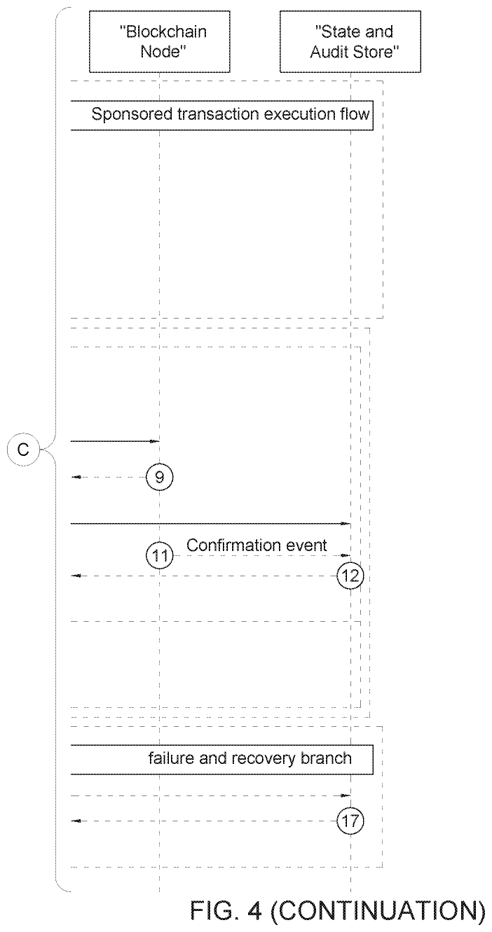

FIG. 4 illustrates the flow of specific data messages between components or layers of the application-blockchain interface system 20 of FIG. 2 as they perform the method shown in FIG. 3. Data flow begins with an authenticated app event and proceeds through a structured intent representation that includes operation context, user reference, tenant or environment scope, risk attributes, and idempotency materials. For example, a user might need to fall within a certain tenant scope that allows them to perform a certain operation within a certain environment subject to certain risk controls and idempotencies. This intent becomes the source artifact for policy decisioning and downstream execution coordination. The policy engine enriches intent metadata with sponsorship outcomes and control tags, which are stored before broadcast to guarantee decision traceability. After submission, blockchain transaction identifiers and confirmation of node receipts associated with the originating app request can be collected into the application's database via API. Lifecycle transitions can be persisted and stored as an auditable timeline so that support teams, auditors, and operators can inspect each state progression without reconstructing events from disconnected systems.

In some embodiments, the application 12 being interfaced with a blockchain network 30 is a data sovereignty application, in whole or in part. In such an application, data which one user owns and wishes to store securely outside of a blockchain network, sometimes referred to as off-chain, can be made available to another user who wishes to purchase, license, or otherwise obtain access to it through a transaction executed on a blockchain network. The backend data sovereignty architecture is founded on the principle of on-chain control combined with off-chain encrypted storage, ensuring a robust framework for data ownership, access, and security. Data ownership is modeled through blockchain identities, primarily utilizing subject_account and operator_account identities, which serve as definitive anchors for data control and management. This approach guarantees that ownership rights are explicitly tied to identifiable entities on the blockchain, facilitating clear and secure governance.

In this architecture, the blockchain retains critical metadata such as hashes, storage pointers, and access permissions, rather than storing the actual data. This enables a secure verification mechanism and efficient access control while maintaining data confidentiality. The on-chain layer primarily handles metadata management, authorization policies, and verification mechanisms, ensuring integrity, revocability, and auditability. This layer maintains objects such as subject_account, operator_account, permission_object, personal_data and content_cards, which serve as verifiable references linking identities, permissions, and data assets. These objects enable a transparent and tamper-evident record of ownership and access rights, facilitating system governance.

Off-chain storage houses the encrypted data itself, which remains inaccessible without proper authorization, ensuring privacy and security for information. The off-chain repository manages the storage of data, including personal data and content assets. This data is encrypted employing robust cryptographic techniques and is accessed through secure adapters such as those that may be found open source at https://github.com/R-Squared-Project/R-Squared-js/tree/feature/%23104_amazon_s3_adapter/lib/storage, which is hereby incorporated herein by reference, along with corresponding repositories. The encryption provides confidentiality and isolates information from direct blockchain exposure. Only metadata and permission references are stored on-chain, as described further below, linking to the off-chain content via hashes and identifiers, thus maintaining data integrity while preserving privacy.

This model allows for the separation of concerns between integrity and confidentiality; integrity being enforced through the on-chain metadata, such as hashes and audit trails that verify data has not been altered, while confidentiality is maintained by encrypting data before storing it off-chain and managing decryption keys and permissions through a structured authorization graph which delineates roles and access rights, allowing revocation and auditability while safeguarding data from unauthorized access. The authorization graph governs access control by defining relationships between subjects, permissions, and data assets. Permissions are encapsulated within permission_object data structures stored on-chain, which specify roles such as read, write, or revoke. Such permission_object structures form a dynamic and revocable graph, enabling real-time updates and reinforcement of access policies. Validation of permissions relies on on-chain metadata, ensuring a trusted source of truth for authorization decisions.

Plug-in-based exposure architecture extends system capabilities through modular plug-ins, notably content_cards data structures. These plug-ins act as gateways to off-chain stored data and enable functions such as content retrieval, permission management, and validation. Access to plug-ins is tightly secured by permission controls embedded within the permission_object, ensuring that only authorized entities invoke sensitive operations. This plug-in infrastructure promotes extensibility, facilitating seamless integration of new functionalities without compromising core security principles.

Data isolation is achieved through a combination of object separation, encryption, and plug-in gating. Specific objects like personal_data and content_cards are stored in isolated encrypted repositories, preventing cross-contamination and unauthorized access. Plug-in gating further enforces isolation by restricting plug-in invocation rights to entities with verified permissions. This layered approach guarantees that data remains confidential while maintaining controlled and auditable interactions across the system. Overall, the architecture employs a modular, governance-driven design that distinctly separates the off-chain confidentiality layer from the on-chain control and integrity layer. This structure ensures that data ownership, identity association, and permissions are managed securely and transparently, with encryption, object separation, and plug-in gating forming the core strategies for data isolation and system extensibility.

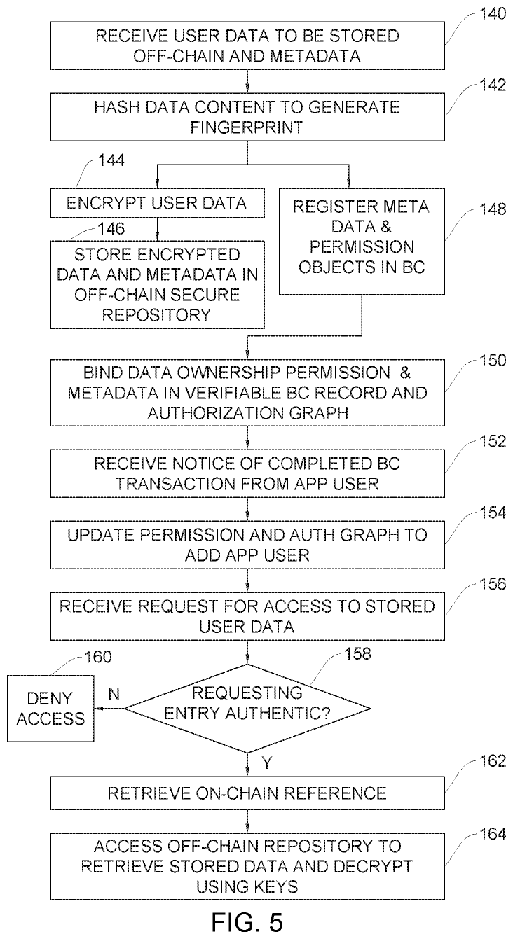

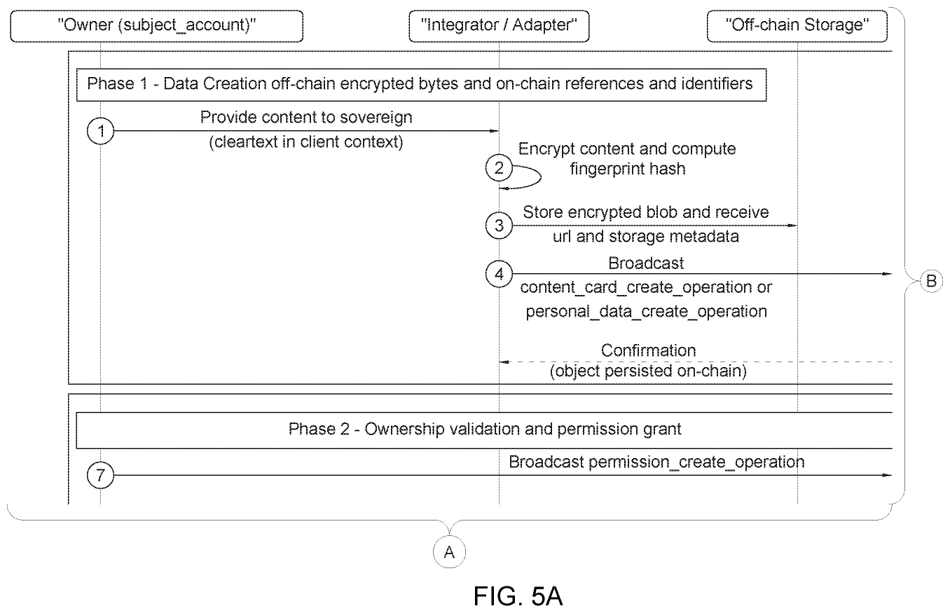

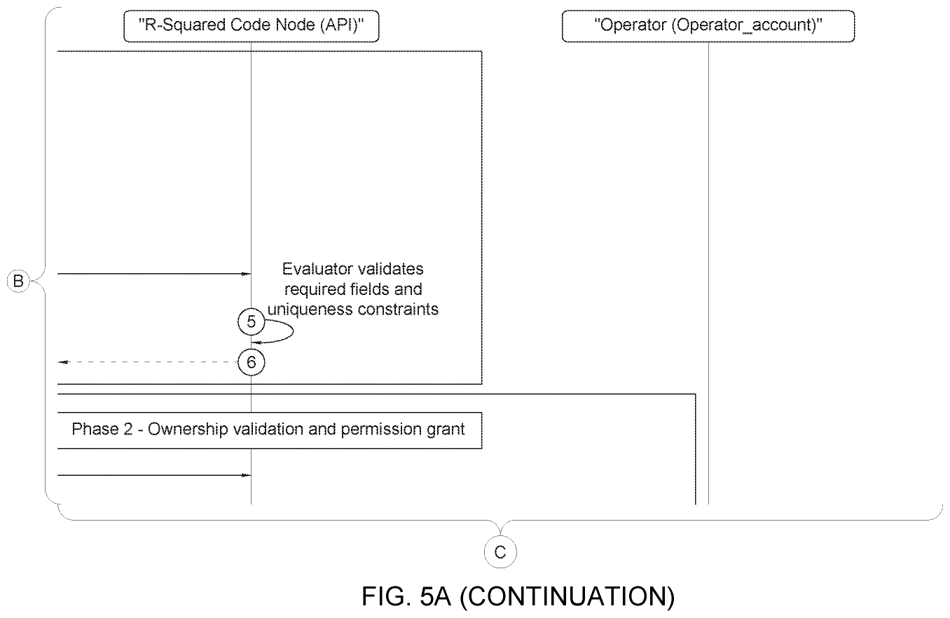

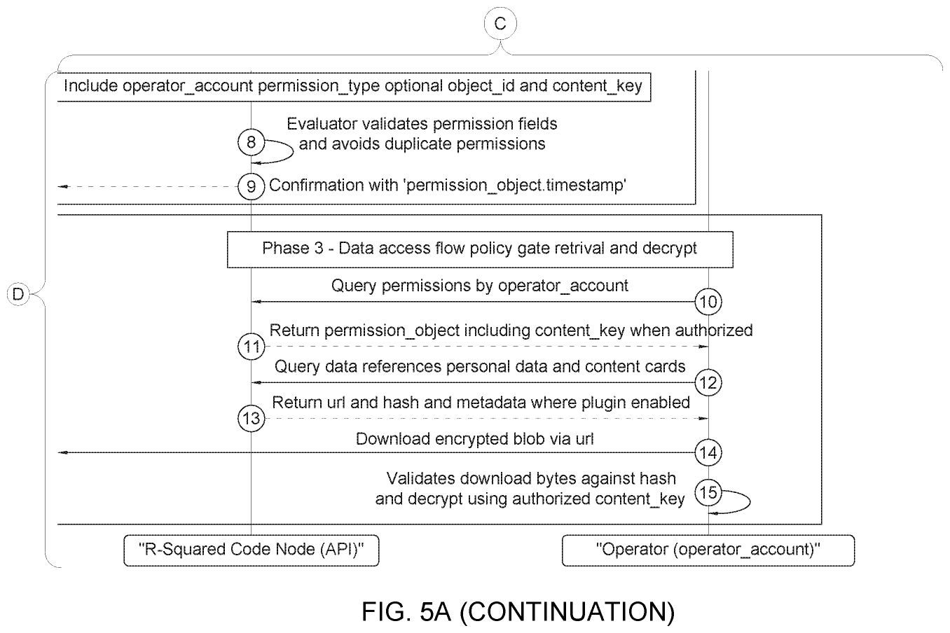

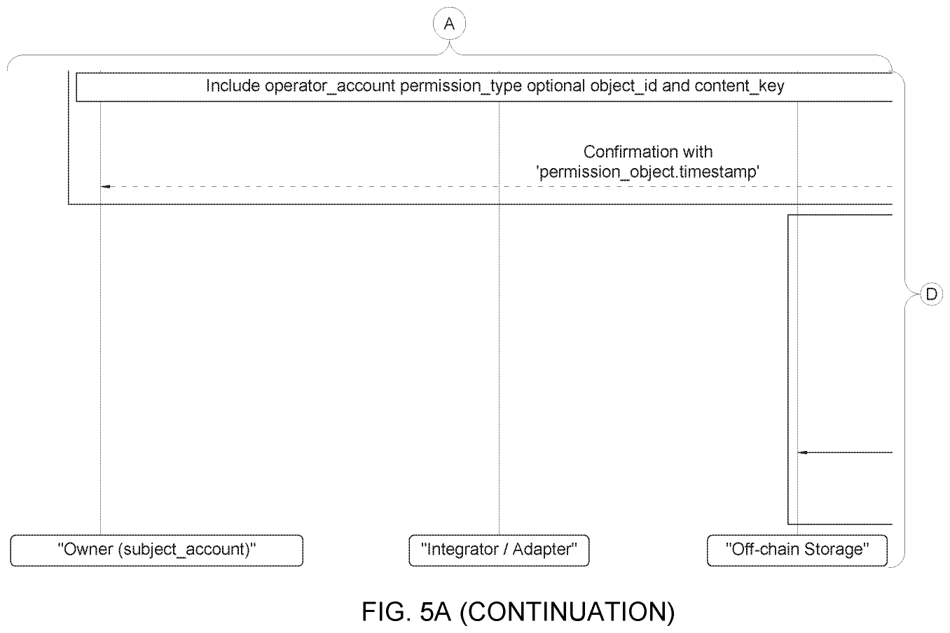

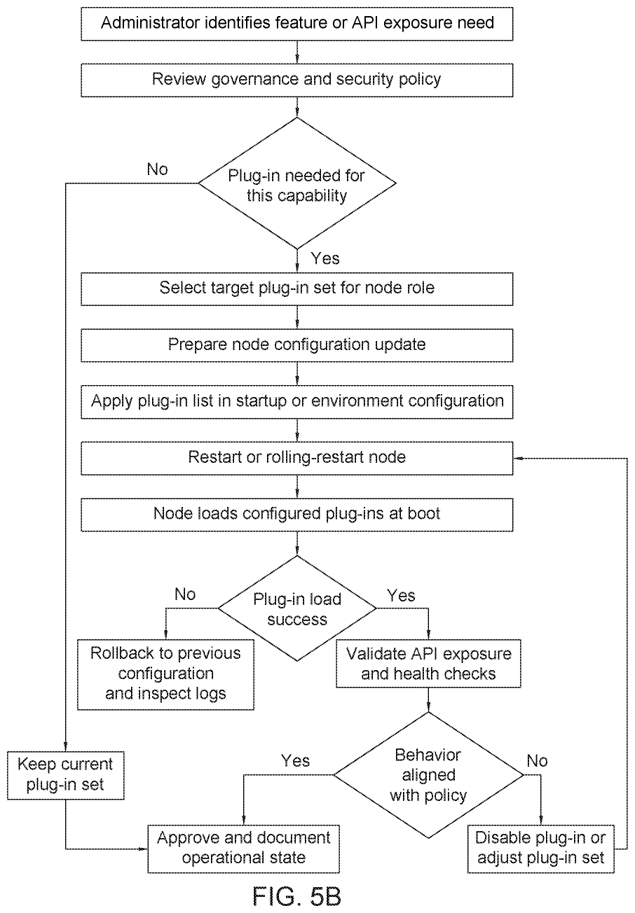

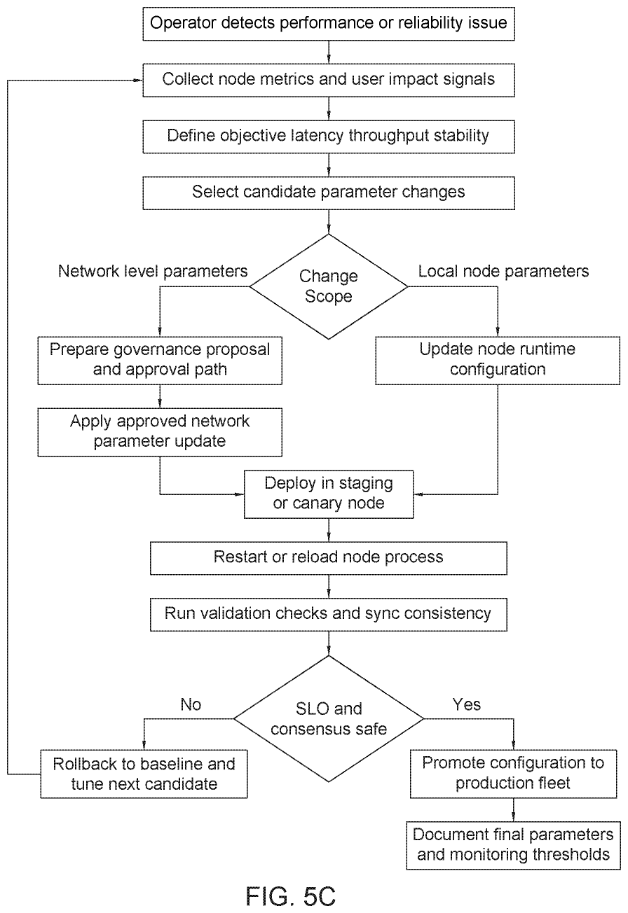

With reference to FIG. 5, a method is provided according to some embodiments in which a data sovereignty application is interfaced with a blockchain to allow on-chain transactions to provide access to off-chain stored data. The data sovereignty application receives the user data to be stored off-chain, along with its metadata, 140. It hashes the content of the data to generate a fingerprint value, 142, which is substantially unique as known to those of skill in the art. It then encrypts the user data using a public key, 144, and stores the encrypted data and its metadata in an off-chain secure repository, 146. The application also interfaces with the blockchain using the application-blockchain interface system 20 to register the metadata for the user data and permission objects in the blockchain network, 148. The permission objects identify users having permission to access the off-chain stored data. The interface system further binds the data ownership data, permission objects and metadata in a verifiable blockchain record and authorization graph, as described above, 150. At this point the user data is ready to be made available to other users via blockchain transactions requested through the application by way of user action.

If such a second user requests access to the stored data through the application, the application sends the user action data to the application-blockchain interface system 20 using the process described above. If the blockchain transaction is completed on the blockchain network by the second user, the interface system 20 receives notice of the completed blockchain transaction, 152, by way of API. The permission object and authorization graph are then updated to add the second user, 154.

When the application receives the second user's request to access the stored data, 156, it confirms the second user is authentic, 158. If the second user is not authentic, the request is denied, 160. Otherwise, the application then requests through the interface system 20 the on-chain reference to the second user, 162, to confirm it has been added to the permission object for this user data. Once confirmed, the application accesses the off-chain repository to retrieve the stored, encrypted user data and triggers decryption by way of the user's private key and corresponding signature, 164. This may be accomplished by, for example, storing a user's encrypted private key on a local browser which is a common method or by storing a user's encrypted private key on their device such as their mobile device which is also a common method. Alternatively, the application may provide access to the off-chain repository to the second user to retrieve the stored encrypted user data and may allow the second user to use that second user's private key to decrypt it once they are permissioned. The decrypted user data is then to be provided to or otherwise made available to the second user in either instance.

FIG. 5A illustrates the flow of specific data messages between components or participants in the method of FIG. 5 when performed on a blockchain network developed using a network development platform available from the assignee of the present application R-Squared Labs LLC. Details on the development platform are available on the assignee's website at
https://rsquared.digital/ and are reproduced in an Appendix to this specification.

As shown in FIG. 5A, when a user uploads data, the client application or authorized entity initiates the process by hashing the content to generate a unique cryptographic fingerprint, ensuring data integrity. The data content is then encrypted using robust cryptographic algorithms, with encryption keys managed securely within the system's key management infrastructure. The encrypted data, along with relevant metadata, such as data type, owner identity, creation timestamp, and encryption details, is stored off-chain in a secure, isolated repository or content management system.

Concurrently, the system registers the associated metadata and permission objects on-chain. This includes creating a permission_object that defines access rights (e.g., read, write, revoke) linked to specific subjects or roles, along with references (hashes, identifiers) to the off-chain encrypted content. The on-chain entries include the content_cards, which binds ownership, permissions, and metadata within a verifiable blockchain record, maintaining tamper-evidence, integrity, and transparency. Permission granting involves updating or revoking the permission_object on-chain to reflect current access policies. These objects are linked via the authorization graph, enabling dynamic and revocable control over data access rights.

When an authenticated entity requests access, the system verifies their permissions by consulting the on-chain permission_object and the authorization graph. Upon permission validation, the system retrieves the encrypted data reference from the metadata registered on-chain. The entity then accesses the off-chain storage via secure adapters or APIs, which enforce encryption controls and ensure authenticated, authorized retrieval. After fetching the encrypted data, the entity decrypts it locally using stored keys, completing the lifecycle from upload to access while maintaining confidentiality, integrity, and control throughout.

Plug-in controls for administrators allow enablement and disablement via configuration settings, allowing administrators to activate or deactivate specific plug-ins based on operational requirements or security considerations. This flexibility ensures that only necessary functionalities are active, reducing attack surface and optimizing system performance. A process for controlling plug-in use and selection is shown in FIG. 5B.

Tuning node parameters to handle expected transaction volumes, optimize response times, and maintain system stability under varying load conditions is important for performance. Regular assessment of throughput, latency, and resource utilization helps identify bottlenecks and implement necessary adjustments. A process for tuning node parameters is shown in FIG. 5C.

As referenced above, the application-blockchain interface includes in some embodiments a service layer 64 which facilitates the creation of new blockchain accounts so that the host application's user action can be broadcast onto the blockchain network as a transaction to be executed. A method performed by the service layer to register the blockchain account is shown in FIG. 6. A host application initiates an account registration request such as via an exposed HTTP endpoint (POST /api/accounts), 200, which includes a proposed account name, metadata, and keys. The service layer captures incoming POST requests for account registration and performs initial validation, 202, to ensure request completeness, correctness, and adherence to established blockchain policies and standards. Validation encompasses checks such as name policy compliance, throttling limits, and optional CAPTCHA verification. This validation step acts as a gating mechanism, preventing invalid or malicious requests from progressing further into the system. If the account registration request is not valid, an error message is returned to the application, 204, via API.

Upon successful validation, the request is forwarded to the service layer, which orchestrates the core logic of account creation. This layer is responsible for transforming validated input data into blockchain-native transaction formats and constructing the necessary operation payloads. It manages transaction lifecycle steps—including serialization, signing, and ensuring deterministic behavior—thereby maintaining repeatability and consistency across operations.

Upon successful validation, then, the service initializes a blockchain connectivity module, 206. Blockchain connectivity modules facilitate communication with the blockchain network and handle selecting the appropriate chain ID, managing fallback nodes in case of network issues, and broadcasting signed transactions to the network. The service also securely loads the registrar system's identity and signing keys retrieved from the registrar system (40 in FIGS. 1 and 2) for the blockchain network, 208, which are used to let the blockchain network authenticate the registration request. The registrar signer entity utilizes these keys to authorize and digitally sign transactions, ensuring that only duly authorized entities can initiate account creation. This process safeguards the integrity of the system and maintains compliance with on-chain authority mechanisms.

The service constructs a blockchain-native account creation operation, embedding parameters such as proposed account name, registrar, referrer, unique identifier, and governance defaults, and serializes it into a transaction for the blockchain, 210. The service uses the unique identifier to enforce idempotency for account creation requests, preventing duplicate account creation in case of retries or network failures. Transactions are constructed by creating an account_create operation, which encodes the necessary account parameters and registration details. The service layer then signs this transaction using the registrar's signing keys, 212, ensuring its validity and authenticity before network submission.

The signed transaction is subsequently broadcast to the blockchain network through the network modules, 214, where it becomes part of the blockchain's immutable ledger, culminating in the creation of a new on-chain account entity. The resulting blockchain account is initialized with predetermined defaults for registrar, referrer, and governance settings, enabling immediate usability within downstream processes such as wallet management and account linking. This orchestrated process ensures end-to-end automation, security, and reliability in onboarding new blockchain participants.

The response from the blockchain network is normalized for clarity and consistency, enabling downstream systems to interpret transaction status and account creation outcomes. If confirmation of successful account creation is received from the blockchain network, 216, the blockchain account information is recorded and provided to the application, 218, via API, and blockchain domain events such as an account-created event, enabling downstream systems (e.g., wallet linking and notification services) to react asynchronously, are emitted, 220. If no confirmation is received or if an error message is returned, the service layer determines based on internal logic whether to retry, 222, and if so repeats the process of broadcasting the signed transaction into the blockchain network, 214. If no attempt to retry is made, then an error message is generated and send to the application, 204, via API.

FIG. 6A illustrates a flow of specific data messages between components or participants in the method of FIG. 6 when performed using a network development platform available from the assignee of the present application R-Squared Labs LLC. The process begins when a client submits a POST request to /api/accounts, including the desired account name and associated public key. The controller receives the request and performs initial validation, such as verifying the completeness of input parameters, ensuring compliance with account naming policies, and checking throttling limits to prevent abuse. If optional security measures are enabled, additional verification like CAPTCHA may be conducted at this stage.

Upon successful validation, the request is forwarded to the service responsible for account creation. The service initializes the blockchain connectivity module, selecting the appropriate network parameters (e.g., chain ID, nodes). It loads the registrar's credentials, including public and private keys, from secure configuration or secret management systems. Using the validated input data, the service constructs an account_create operation, which includes setting authorities, metadata, and any initial configurations. The operation is serialized into a transaction format suitable for blockchain submission. The transaction is then signed deterministically with the registrar's private key to ensure authenticity and prevent replay attacks.

The signed transaction is broadcast to the blockchain network via the connectivity module. The network responds with a confirmation indicating transaction acceptance or rejection. Upon successful inclusion of the transaction on-chain, the system records the account's identity information and transaction details. A response is generated and returned to the client, containing the account identifier, creation status, and relevant on-chain references, confirming the account's activation and readiness for subsequent operations. Upon successful account creation, the system emits domain events.

In some embodiments, the application-blockchain interface system further includes a verified binding layer which binds the host application session with a service or node operating within the blockchain network such as the sponsor wallet service. Such binding provides the following advantages:
achieves a seamless user experience with few or no additional steps or interactions needed after account creation, ensuring users can immediately utilize their new blockchain accounts without redundant or confusing workflows;
maintains a single source of truth by capturing a comprehensive, canonical record of each account creation event, including transaction ID, block context, account name, and authority details, which serves as the definitive reference for the account's lifecycle;
ensures safe coexistence with host applications securely associating blockchain identities with business users post-linkage, avoiding interference with existing application workflows by allowing blockchain related workflows to work seamlessly alongside and/or with non-blockchain related workflows while preserving security boundaries;
promotes idempotency and reproducibility by structuring outcomes that can be reliably consumed even in scenarios involving network retries or failures, thereby maintaining consistent wallet state and application integrity;
for existing blockchain accounts, supports continuous discovery and synchronization of account states through data components such as AccountRefStore (to derive candidate account identifiers (account references) from the stored keys through deterministic algorithms (computer procedures to ensure that a specific input will always produce the same exact output with a predictable sequence of states), generating potential accounts for linkage based on user key material), and ChainStore (to fetch on-chain data to validate whether the user controls each candidate account such as by verifying the cryptographic signatures), which reconcile provisional registration metadata with the actual on-chain state, ensuring data accuracy and consistency over time;
upholds the separation of concerns among application authentication, wallet identity management, and binding mechanisms, allowing each aspect to evolve independently while maintaining secure and deterministic linkages;
incorporates non-sensitive identifiers in binding requests carried along with signatures generated from the user's private keys which, along with a data field, for example manuallinksession_id data field, maintains correlation across processes and ensures traceability by linking user actions to specific validation or binding sessions and tracking the session identifier. This is useful for users with an existing blockchain account who've linked their blockchain account by way of manual entry of user name or public key by way of UI 16 in the host application 12, for the purpose of binding such existing blockchain account. A method for this is illustrated by the data flow diagram in FIG. 7D.

A method of binding in accordance with some embodiments is illustrated in FIG. 7. The method is described using the sponsor wallet service, though it may be performed the same with other blockchain related services. A short-lived, single-use nonce data value that is bound to and thereby identifies a current application session and application user (client_id or app origin) is generated. The wallet constructs a canonical binding payload, 302, that includes schema_version, app_user_id (or backend-issued subject identifier), chainid, AccountName, the nonce value, and an issuedate timestamp, then signs that payload on-chain using a private key that is currently authorized on-chain for the linked account (for example the active key), 304. The wallet sends the signature, and sends the public key used for signing, and the same payload fields to the application's backend, 306.

The backend verifies that the nonce is valid and unused, 308, verifies the signed and validated payload transaction, 310, and checks live on-chain authority to confirm that the signing public key is currently permitted for that account, 312. If any of these three checks fail, an error message is sent to the application, 314 via API. If all checks pass, the backend stores a binding record in the application's database (app_user_id, chainid, AccountName, bound_at, and optional registrationrequestid), 316, and generates an application token or session update using standard methods, 318, that carries the bound blockchain identity claims for subsequent API calls allowing ongoing synchronization. The nonce is consumed and cannot be reused, so its data value is stored so that it can be used to check against future nonce data values.

The binding record is securely recorded in the application's database, linking the user's application identity to the blockchain account. Subsequent transactions utilize the linked account context, enabling seamless interaction with blockchain assets and services. Throughout this lifecycle, correlation fields such as registrationrequestid, transactionid, AccountName, and timestamps ensure traceability and auditability.

A method for functional and data flows for registering and binding a new blockchain account is illustrated by the data flow diagram in FIG. 7C.

FIG. 7A illustrates how a host product connects after linking—embedded wallet, redirect or deep link, or backend-mediated binding—without owning keys, for new blockchain accounts.

FIG. 7B illustrates a flow of specific data messages between components or participants in the method of FIG. 7 when performed using a network development platform available from the assignee of the present application R-Squared Labs LLC. The user initiates the account creation process through the wallet interface, providing necessary identification and intent information. WalletActions validate the user action, ensuring the request aligns with current account management policies, and allocate a unique registrationrequestid to track the process. The registration service accepts the registration intent, signs the transaction, and broadcasts it to the blockchain network. Simultaneously, it begins tracking the transaction status to confirm successful inclusion on-chain. The registration service verifies the created blockchain account against the initial registration intent by matching account identifiers, chain id, and associated metadata. Upon successful on-chain account creation and validation, the registration service emits a RegistrationOutcome with a status of confirmed. The wallet receives the confirmation and updates the local AccountStore by upserting the new account data, including references, registration details, and related metadata. A notification is sent to the user interface, reflecting the updated account state, and automatic linking is finalized to associate the blockchain account with the wallet's local account record. The data flow architecture emphasizes strict separation between application authentication and key custody within the wallet. It also prioritizes idempotency, achieved through operation keying and verification mechanisms, to ensure that multiple submissions or recoveries do not result in inconsistent states or duplicated accounts. It connects to the registration service which itself shows idempotent accept, orchestration on chain, terminal RegistrationOutcome, and AccountActions or AccountStore—which is useful because it shows exactly how the outcome is produced and consumed downstream.

As mentioned above, the application-blockchain interface system 20 may include an additional service module, the External Rate Service (ERS) module, that retrieves and analyzes historical and real-time market data to compute recommended exchange rates for exchanging tokens in the blockchain network, particularly non-native tokens newly issued to the new blockchain account belonging to a host application with native tokens. The ERS analyzes market trends, order flow, and liquidity metrics to adjust asset exchange parameters dynamically and updates the system by submitting rate adjustments that, once implemented, influence or enhance user or sponsorship activity on the blockchain by ultimately allowing a token other than the native token to be used to pay for blockchain transactions by way of further sponsored payment of the blockchain transaction; a sort of waterfall of sponsorship.

Such a blockchain network is structured, such as by way of hardcoded C++ logic, to allow only a special user class called a Clearing House Participant (CHP) to issue new non-native tokens, or stablecoins, on the blockchain. Such a CHP may issue stablecoins directly onto the blockchain, or bridge to another blockchain using a cross-chain bridge for a wrapped version of the native assets of such a bridged-to blockchain, whether such bridged-to blockchain is a stablecoin provider, or has its own native digital asset such as Ethereum or Bitcoin. Such cross-chain bridge technology is standard and is also made available from the assignee of the present application R-Squared Labs LLC. A CHP is commercially incentivized to build and run such an enterprise because the blockchain is also technically structured, such as by way of hardcoded C++ logic, to allow a CHP to charge a separate fee, remitted directly to them in its issued token, when any trade involving its issued token is executed.

When it's necessary to allow a brand new user to the system, such as a new account created to carry out a transaction requested by a user through an application as described above, with no native tokens, a mechanism is needed to acquire the native token by way of using the issued token to purchase native tokens within the DEX in order to then pay for the transactions of their users on an ongoing sponsored basis. To acquire the native token with the issued token, an existing account must pay for that blockchain transaction using native tokens that they already have, and if they do not have any native tokens, they can't pay for that transaction. Such a new account, such as a host application 12, may use non-native tokens issued by the CHP that they, the host application 12, can acquire way of a cross-chain bridge, to pay for an initial transaction to then buy native tokens in the DEX, continue to use their non-native tokens to pay for transactions on behalf of users, or allow their users to pay for the transactions directly also in non-native tokens. This is where the next leg of the payment sponsorship waterfall kicks in. The blockchain is technically structured by way of hardcoded C++ logic to, when a user, as represented by a sponsor wallet service or otherwise, “pays” for a blockchain transaction in non-native tokens, they are actually paying the CHP in non-native tokens who then pays for the actual blockchain transaction with the CHP's native tokens which have been already acquired by them, whether by initial native token issuance and distribution at blockchain genesis or otherwise. The blockchain mechanics are implemented to perform such a process automatically and seamlessly.

However, there's a problem with respect to price volatility. If, for example, the amount that the CHP gets recompensed in non-native tokens as determined by the exchange rate is now not enough for them to replenish their supply of native tokens by using such non-native tokens to purchase more native tokens on the DEX that would be enough to pay for the next transaction or number of transactions, then the CHP may be drained of their native tokens and the host application's ability to perform blockchain operations on behalf of their users, whether by way of being able to perform the transaction to purchase their initial supply of native tokens, or pay for their users'transactions in non-native tokens on an ongoing basis if so preferred, will end. The ERS systematically updates the amount of newly issued tokens they are paid by analyzing market price changes. The ERS is a necessary risk mitigator for any CHP who might otherwise run out of native tokens used to pay for blockchain transactions and not be recompensed in enough issued tokens in return to be able to go to the DEX and purchase more native tokens and preserve their enterprise. If that happened, the DEX itself could fail because CHPs would stop issuing tokens, and therefore the system would not be self-sufficient for application developers to have a steady place to acquire native tokens, which are needed to operate their application, nor would there be CHPs to sponsor those costs in non-native tokens, such as stablecoins, wrapped stablecoins or other wrapped digital assets, for them; in which case an entire data sovereignty system may therefore be rendered moot.

To resolve this problem, the ERS adjusts the exchange rate used by the blockchain between a new token issued and the native token based upon price volatility when comparing the two tokens. For example, in a DEX trade where one native token is sold for two issued tokens, in an active market, second by second, such a price can fluctuate up or down on an ongoing basis. Someone new to the blockchain network, such as a new account created to carry out a transaction requested by a user through an application as described above, has no native tokens. The ERS systematically updates the amount of non-native tokens they need to pay for a transaction by analyzing market price changes, based upon algorithmic parameters.

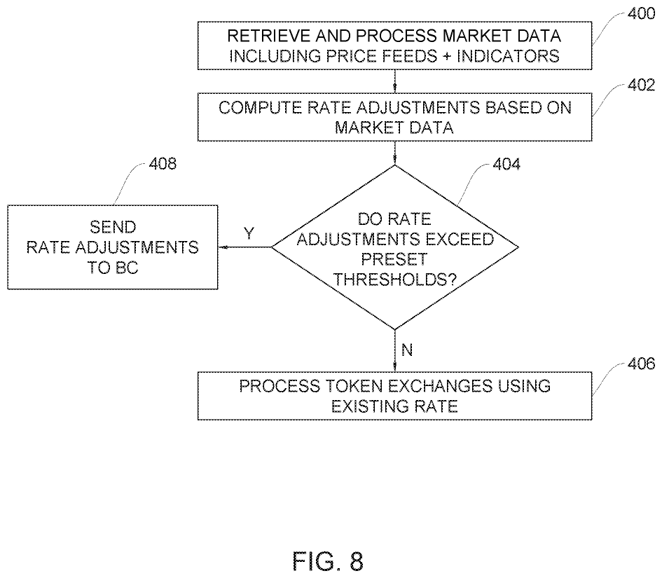

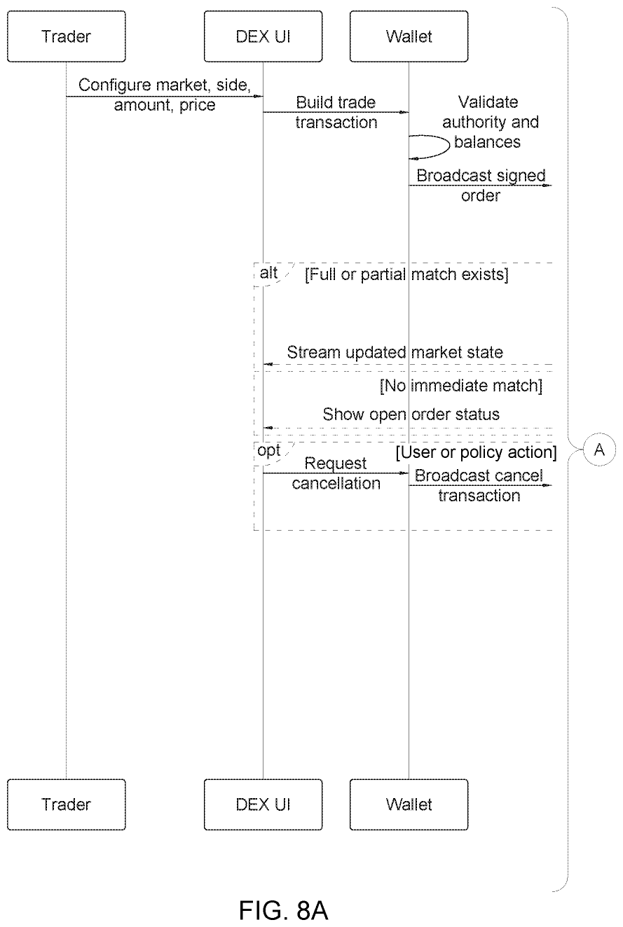

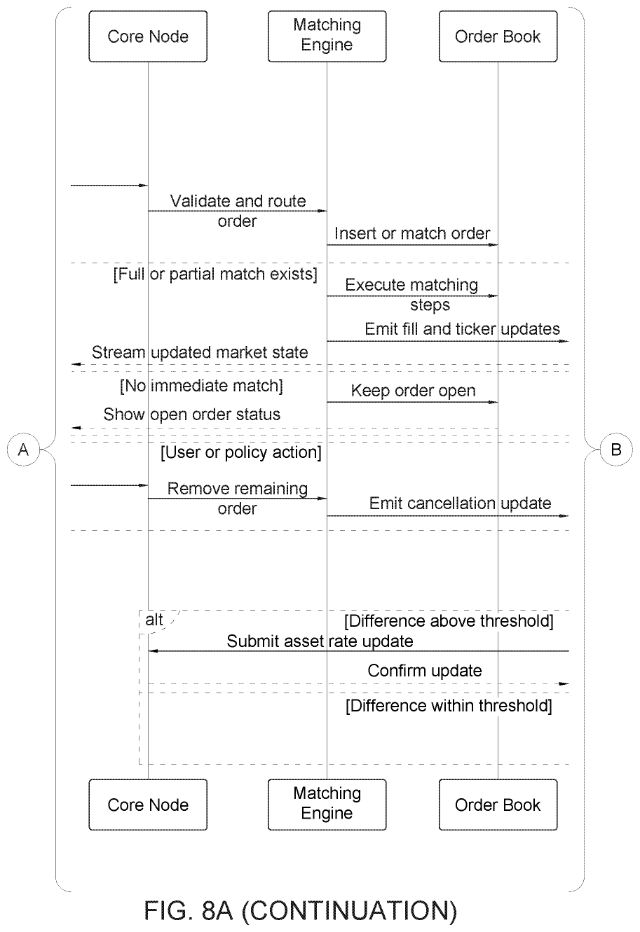

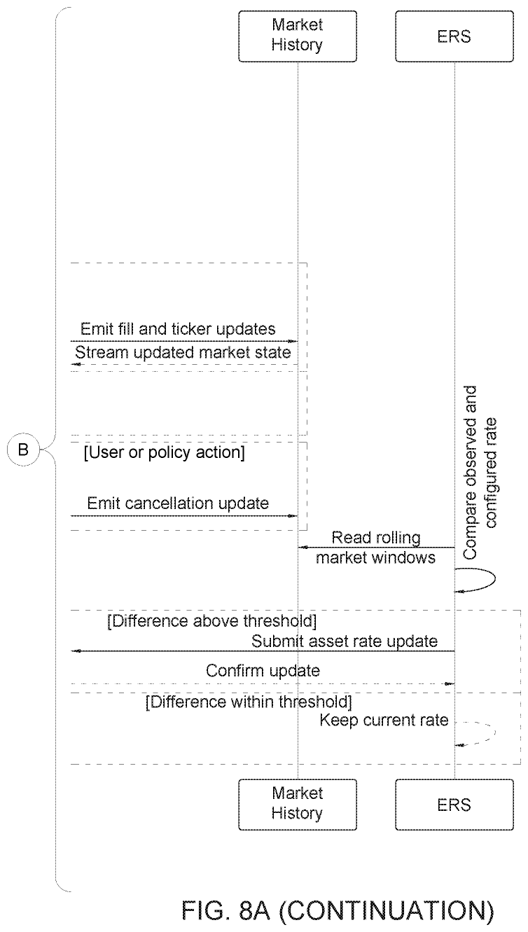

Referring to FIG. 8, the process of computing exchange rates in accordance with some embodiments starts by the ERS retrieving market data from the blockchain's DEX, including price feed data and price indicator data, 400. The ERS monitors blockchain activity by running its own node on the blockchain, allowing it to collect the market data and exchange rate data itself, both historically and on a real-time basis, and ingest it into its database, using known methods for connection such as an API through a WebSocket Secure connection, known methods for monitoring such as an event listener, and known methods for ingestion and data management such as Extract, Transform, Load and post-load indexing. The ERS module is programmed to where if, for example, in any 1 minute, 5 or more trades are executed, an exchange rate will be computed algorithmically, 402, using, for example, a Volume Weighted Average Price (VWAP) algorithm, where VWAP=Σ(Price*volume)/Σ Volume.

The ERS may then update the exchange rate on the blockchain by way of a WebSocket Secure blockchain node connection if the existing observed exchange rate differs from the newly calculated exchange rate and based on whether or not the computed rate adjustment exceeds one or more of ERS's preset thresholds, 404, such as a certain deviation value of the existing exchange rate versus the newly calculated exchange rate. The ERS is programmed to update the exchange rate if such a threshold or thresholds are exceeded; for example, “if newly calculated exchange rate>threshold (1)=true, update exchange rate with newly calculated exchange rate.” If the thresholds are exceeded, the ERS submits a transaction to update the exchange rate to the blockchain network, 408, which performs validation checks and upon successful validation then uses the updated rate to process a payment of non-native tokens to the CHP from the host application in return for the CHP paying the blockchain directly for the host application's transactions in native tokens, as described above. If a threshold is not exceeded, the ERS does not send a rate adjustment to the blockchain and the existing rate is left intact, 406.

FIG. 8A illustrates a flow of specific data messages between components or participants in the method of FIG. 8 when performed using a network development platform available from the assignee of the present application R-Squared Labs LLC. The trader begins by accessing the trading interface of the decentralized exchange (DEX), selecting the desired market for asset exchange. The trader reviews the current order book, including bids and asks, to assess market conditions and inform their trading decision. Once ready, the trader signs the order using their private key to ensure authenticity and submits it to the blockchain network.

The blockchain receives the signed order, performs validation checks to verify signature authenticity, order parameters, and compliance with protocol rules. Upon successful validation, the order is added to the on-chain order book, updating the environment's state.

The blockchain matching engine uses protocol code to compare any validated incoming order against the order book, executing trade matches when conditions are met. When a match occurs, a trade is executed on-chain, and a fill event is emitted, indicating completed transactions between counterparties. The execution details are recorded in the on-chain history for transparency and auditability. Separately, the ERS retrieves external market data such as price feeds and market indicators. The ERS processes this data to compute appropriate rate adjustments based on predefined thresholds and algorithms. If the computed rate adjustments exceed preset thresholds, ERS submits proposed updates to the blockchain, signaling the need for asset parameter modifications. The on-chain system reviews and, if validated, applies these ERS-driven updates, ensuring asset exchange rates reflect current market conditions. This cycle maintains a dynamic feedback loop, ensuring that on-chain exchange rates reflect current market conditions, thus maintaining operational integrity.

The ERS scheduling for rate evaluations operates based on predefined volume windows and thresholds. Evaluations may be constant, or may be triggered at regular intervals or when certain volume or price deviation parameters are met, thereby balancing responsiveness with resource efficiency. The ERS may employ a flexible scheduling mechanism that adapts to market activity, performing evaluations more frequently during high-volume periods and reducing frequency during low activity to conserve computational resources and avoid unnecessary on-chain updates. Rate adjustments derived from ERS evaluations may be executed through scheduled transactions, which may be batched and submitted at specified intervals to minimize on-chain congestion and optimize fee consumption.

User devices/mobile devices as described throughout this description may comprise computing devices (e.g., laptops, personal digital assistants (PDA), cellular phones, smartphones, tablet computers, smart watches and smart wearable devices, or any computing device having a central processing unit and memory unit capable of connecting to a network). Client devices may also comprise a graphical user interface (GUI) or a browser application provided on a display (e.g., monitor screen, LCD or LED display, projector, etc.).

The client devices may vary in terms of capabilities or features. For example, a web-enabled client device, which may include one or more physical or virtual keyboards, mass storage, one or more accelerometers, Bluetooth capabilities, a mobile hotspot, one or more gyroscopes, global positioning system (GPS) or other location identifying type capability, or a display with a high degree of functionality, such as a touch-sensitive color 2D or 3D display. Client devices may also include or execute an application to communicate content, such as, for example, textual content, multimedia content, or the like. The client devices may also include or execute an application to perform a variety of possible tasks, such as browsing, and searching.

Client devices may include or execute a variety of operating systems, including a personal computer operating system, such as a Windows, Mac OS or Linux, or a mobile operating system, such as iOS, Android, or Windows Phone, or the like. The client devices may include or may execute a variety of possible applications, such as a client software application enabling communication with other devices, such as communicating one or more messages, such as via email, short message service (SMS), multimedia message service (MMS), or messages on social network platforms including, for example, Facebook, LinkedIn, X, Pinterest, Snapchat, or Instagram, to provide only a few possible examples.

Networks as described herein may be any suitable type of network allowing transport of data communications across thereof. The network may couple devices so that communications may be exchanged, such as between servers and client devices or other types of devices, including between wireless devices coupled via a wireless network, for example. Network may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof.

Communications and content stored and/or transmitted to and from client devices may be encrypted using, for example, the Advanced Encryption Standard (AES) with a 128, 192, or 256-bit key size, or any other encryption standard known in the art.

Servers, as described herein, may vary widely in configuration or capabilities but are comprised of at least a special-purpose digital computing device including at least one or more central processing units and memory. A server may also include one or more of mass storage devices, power supplies, wired or wireless network interfaces, input/output interfaces, and operating systems, such as Windows Server, Mac OS X, Unix, Linux, FreeBSD, or the like. In an example embodiment, a server may include or have access to memory for storing instructions or applications for the performance of various functions and a corresponding processor for executing stored instructions or applications. For example, the memory may store an instance of the server configured to operate in accordance with the disclosed embodiments. A server is operative to receive requests from client devices and process the requests to generate responses to the client devices across the network.

According to one embodiment, one or more components within the system may communicate with each other via a communications interface, bus, or channel. Alternatively, one or more components may be software loaded in various memory devices or locations and executed via one or more processors or processing cores.

FIGS. 1 through 8A are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

### APPENDIX

### Building a DevNet

We need to begin with a functioning blockchain network, or developer network, or “DevNet” that's purpose-built to enable off-chain storage of files of any type or format on servers of a developer's choosing—e.g., a cloud service or directly upon an on-premise infrastructure.

Such a blockchain can be built and launched by way of open source code and instructions within the core repository of the R-Squared project located at https://github.com/R-Squared-Project. Such a core blockchain, is a foundation for utilizing cryptographic signatures from a key pair to share access to files stored off-chain on any server by way of decryption with any other established account on the same blockchain.

For the core blockchain, a developer can build on Ubuntu 18.04 LTS (64-bit) using the following build script:

git clone https://github.com/R-Squared-Project/R-Squared-core.git
cd R-Squared-core
git checkout master # may substitute ″master″ with current release tag
git submodule update -- init --recursive
mkdir build
cd build
cmake -DCMAKE_BUILD_TYPE=Release ..
make

As the next step, a developer can use the docker image from the latest release within the above referenced core repository from the R-Squared project to build and run a fully functional blockchain node referred to as a “witness node”. Such a node is essential for producing blocks. A developer can alternatively build their own docker image referencing the following set of information and instructions:

The Dockerfile performs the following steps:
1. It will obtain a base image (phusion/baseimage: 18.04-1.0.0)
2. It will install required dependencies using apt
3. It will add rsquared-core source code into the container
4. It will update git submodules
5. It will perform cmake with build type Release
6. It will run make and make_install (which will install binaries into /usr/local/bin
7. It will purge source code off of the container
8. It will add a local rsquared user and set $HOME to/var/lib/rsquared
9. It will make /var/lib/rsquared and /etc/rsquared into a docker volume
10. It will expose ports 8090 and 2771
11. It will add default config from docker/default_config.ini and entry point script
12. And it will run entry point script by default

The entry point simplifies the use of parameters for the witness_node (which is run by default when spinning up the container).

A developer can then launch a build process with a command
$ docker build $RSQUARED_CORE_DIR-t local/rsquared-core: latest

Here are supported variables:
$RSQUAREDD_SEED_NODES
$RSQUAREDD_RPC_ENDPOINT
$RSQUAREDD_PLUGINS
$RSQUAREDD_REPLAY
$RSQUAREDD_RESYNC
$RSQUAREDD_P2P_ENDPOINT
$RSQUAREDD_WITNESS_ID
$RSQUAREDD_PRIVATE_KEY
$RSQUAREDD_TRACK_ACCOUNTS
$RSQUAREDD_PARTIAL_OPERATIONS
$RSQUAREDD_MAX_OPS_PER_ACCOUNT
$RSQUAREDD_ES_NODE_URL
$RSQUAREDD_TRUSTED_NODE

The default configuration is:

p2p-endpoint = 0.0.0.0:2771
rpc-endpoint = 0.0.0.0:8090
enable-stale-production = false
max-ops-per-account = 1000
partial-operations = true

With docker compose, multiple nodes can be managed with a single docker-compose.yaml file:

```
version: ′3′
services:
  main:
    # Image to run
    image: local/rsquared-core:latest
    #
    volumes:
      - ./docker/conf/:/etc/rsquared/
    # Optional parameters
    environment:
      - RSQUAREDD_ARGS=--help
or
version: '3'
services:
  fullnode:
    # Image to run
    image: local/rsquared-core:latest
    environment:
    # Optional parameters
      - RSQUAREDD_ARGS=--help
    ports:
      - ″0.0.0.0:8090:8090″
    volumes:
    - ″rsquared-fullnode:/var/lib/rsquared″
```

This container is properly registered with the GitHub Container registry:
$ docker pull ghcr.io/r-squared-project/r-squared-core:latest

As next step, this is an instruction on how to use docker compose to set up a trusted full node together with a delayed node:

```
version: ′3′
services:
  fullnode:
    image: ghcr.io/r-squared-project/r-squared-core:latest
    ports:
      - ″0.0.0.0:8090:8090″
    volumes:
    - ″rsquared-fullnode:/var/lib/rsquared″
  delayed_node:
    image: ghcr.io/r-squared-project/r-squared-core:latest
    environment:
      - ′RSQUAREDD_PLUGINS=delayed_node witness′
      - ′RSQUAREDD_TRUSTED_NODE=ws://fullnode:8090′
    ports:
      - ″0.0.0.0:8091:8090″
    volumes:
    - ″rsquared-delayed_node:/var/lib/rsquared″
    links:
    - fullnode
volumes:
  rsquared-fullnode:
```

As next step, in order to launch the docker image, a config file will need to be prepared. That config file is located at https://github.com/R-Squared-Project/R-Squared-core/blob/development/ docker/default_config.ini.

As next step, within the config, “seed-node=” will need to be changed so that this variable contains the IP addresses and port numbers of other DevNet nodes.

As next step, a witness node can be launched with:
./programs/witness_node/witness_node

The node will automatically create a data directory including a config file. You can exit the node using Ctrl+C and setup the command-line wallet by editing witness_node_data_dir/config.ini as follows:
Rpc-endpoint=127.0.0.1:8090

After starting the witness node again, in a separate terminal you can run:
./programs/cli_wallet/cli_wallet

Set your inital password:
>>> Set_password <PASSWORD>
>>> Unlock <PASSWORD>

The cli_wallet or API interfaces to the witness node wouldn't be fully functional unless the witness node is fully synchronized with the blockchain. The cli_wallet command info will show result head_block_age which will tell you how far you are from the live current block of the blockchain.

To check your current block:
>>> info

As a general security matter beyond a DevNet environment, when sending private keys over this connection, rpc-endpoint should be bound to localhost for security.

Use the command help to see all available wallet commands.

There are several different API's. Each API has its own ID. When running witness_node, initially two API's are available: API 0 provides read-only access to the database, while API 1 is used to login and gain access to additional, restricted API's.

Here is an example using wscat package from npm for WebSockets:

$ npm install -g wscat
$ wscat -c ws://127.0.0.1:8090
> {″id″:1, ″method″:″call″, ″params″:[0,″get_accounts″,[[″1.2.0″]]]}
< {″id″:1, ″result″:[{″id″:″1.2.0″, ″annotations″:[ ], ″membership_expiration_date″:″1969-12-
31T23:59:59″,″registrar″:″1.2.0″,″referrer″:″1.2.0″,″lifetime_referrer″:″1.2.0″,″network_fee_percentage″:2000,
″lifetime_referrer_fee_percentage″:8000,″referrer_rewards_percentage″:0,″name″:″committee-account″,″owner″:
{″weight_threshold″:1,″account_auths″:[ ],″key_auths″:[ ],″address_auths″:[ ]},″active″:
{″weight_threshold″:6,″account_auths″:[[″1.2.5″,1],[″1.2.6″, 1],[″1.2.7″,1],[″1.2.8″,1],[″1.2.9″,1],[″1.2.10″,1],
[″1.2.11″,1],[″1.2.12″,1],[″1.2.13″,1],[″1.2.14″,1]],″key_auths″:[ ],″address_auths″:[ ]},″options″:
{″memo_key″:″GPH1111111111111111111111111111111114T1Anm″,″voting_account″:″1.2.0″,″num_witness″:0,
″num_committee″:0,″votes″:[ ],″extensions″:[ ]},″statistics″:″2.7.0″,″whitelisting_accounts″:
[ ],″blacklisting_accounts″:[ ]}]}

The same thing can be done using an HTTP client such as curl for API's which do not require login or other session state:

$ curl --data ′{″jsonrpc″: ″2.0″, ″method″: ″call″, ″params″: [0, ″get_accounts″, [[″1.2.0″]]], ″id″: 1}′
http://127.0.0.1:8090/rpc
{″id″:1,″result″:[{″id″:″1.2.0″,″annotations″:[ ],″membership_expiration_date″:″1969-12-
31T23:59:59″,″registrar″:″1.2.0″,″referrer″:″1.2.0″,″lifetime_referrer″:″1.2.0″,″network_fee_percentage″:2000,
″lifetime_referrer_fee_percentage″:8000,″referrer_rewards_percentage″:0,″name″:″committee-account″,″owner″:
{″weight_threshold″:1,″account_auths″:[ ],″key_auths″:[ ],″address_auths″:[ ]},″active″:
{″weight_threshold″:6,″account_auths″:[[″1.2.5″,1],[″1.2.6″,1],[″1.2.7″,1],[″1.2.8″,1],[″1.2.9″,1],[″1.2.10″,1],
[″1.2.11″,1],[″1.2.12″,1],[″1.2.13″,1],[″1.2.14″,1]],″key_auths″:[ ],″address_auths″:[ ]},″options″:
{″memo_key″:″GPH1111111111111111111111111111111114T1Anm″,″voting_account″:″1.2.0″,″num_witness″:0,
″num_committee″:0,″votes″:[ ],″extensions″:[ ]},″statistics″:″2.7.0″,″whitelisting_accounts″:
[ ],″blacklisting_accounts″:[ ]}]}

API 0 is accessible using regular JSON-RPC:
$ curl--data ‘{“jsonrpc”: “2.0”, “method”: “get_accounts”, “params”: [[“1.2.0”]], “id”: 1}’ http://127.0.0.1:8090/rpc

As next step, refer to the JSON file for DevNet called “genesis-dev.json” within the core repository to modify initial operation costs without having to worry about private keys within a DevNet environment. That file is located at https://github.com/R-Squared-Project/R-Squared-core/blob/v1.0.0/libraries/egenesis/genesis-dev.json.

Use this key to produce blocks with the genesis-dev.json Genesis. The following line may be added directly to config.ini:

private-key =
[″RQRX6JaiMEZZ57Q75Xh3kVbJ40wX13p7f1kkV76B3xLNFuWHVbRSyZ″,
″5KXbCDyCPL3eGX6xX5uJHVw0AYheF7L5fKf67oQocgJA8kNvVHF″]

As next steps:

Import an account which has sufficient funds for DevNet use:

>>> import_key rsquaredchp1 5KXbCDyCPL3eGX6xX5uJHVwoAYheF7L5fKf67oQocgJA8kNvVHF
>>> import_balance rsquaredchp1 [″5KXbCDyCPL3eGX6xX5uJHVwoAYheF7L5fKf67oQocgJA8kNvVHF″] true
>>> upgrade_account rsquaredchp1 true

Elect committee members:

>>> vote_for_committee_member rsquaredchp1 init0 true true
>>> transfer rsquaredchp1 init0 100000 RQRX ″here is the cash″ true
>>> vote_for_committee_member rsquaredchp1 init1 true true
>>> transfer rsquaredchp1 init1 100000 RQRX ″here is the cash″ true
>>> vote_for_committee_member rsquaredchp1 init2 true true
>>> transfer rsquaredchp1 init2 100000 RQRX ″here is the cash″ true
>>> vote_for_committee_member rsquaredchp1 init3 true true
>>> transfer rsquaredchp1 init3 100000 RQRX ″here is the cash″ true
>>> vote_for_committee_member rsquaredchp1 init4 true true
>>> transfer rsquaredchp1 init4 100000 RQRX ″here is the cash″ true
>>> vote_for_committee_member rsquaredchp1 init5 true true
>>> transfer rsquaredchp1 init5 100000 RQRX ″here is the cash″ true
>>> vote_for_committee_member rsquaredchp1 init6 true true
>>> transfer rsquaredchp1 init6 100000 RQRX ″here is the cash″ true
>>> vote_for_committee_member rsquaredchp1 init7 true true
>>> transfer rsquaredchp1 init7 100000 RQRX ″here is the cash″ true
>>> vote_for_committee_member rsquaredchp1 init8 true true
>>> transfer rsquaredchp1 init8 100000 RQRX ″here is the cash″ true
>>> vote_for_committee_member rsquaredchp1 init9 true true
>>> transfer rsquaredchp1 init9 100000 RQRX ″here is the cash″ true
>>> vote_for_committee_member rsquaredchp1 init10 true true
>>> transfer rsquaredchp1 init10 100000 RQRX ″here is the cash″ true

Prepare the account that can register new users:

>>> import_key chpaccount4 5K2oq1pLFSyBsgLyjHNmRos7qBwxcJhXYBXT9ddmjF4UPf4bomq
>>> import_balance chpaccount4 [″5K2oq1pLFSyBsgLyjHNmRos7qBwxcJhXYBXT9ddmjF4UPf4bomq″] true
>>> upgrade_account rsquaredchp4 true

### Using the Chain for File Sharing

The next piece of infrastructure can be accomplished by following the below steps:
1. Launch the docker image and deploy a separate node, however this time it's a development node and not a witness node.
2. Utilize the content card plug-in for a development node for multiple different files and file types stored off-chain located
   at https://github.com/R-Squared-Project/R-Squared-core/tree/development/libraries/plugins/ content_cards
3. You can reference the following JS SDK branch to integrate with a number of different commercially available file storage frameworks, or you may build your own adapter to a storage of your choice by referencing the methods used in the source code: https://github.com/R-Squared-Project/R-Squared-js/tree/feature/ %23104_amazon_s3_adapter/lib/storage
   a. For Google Drive you should obtain credentials, download and store them to google_oauth2_keys.json. How to obtain credentials: https://developers.google.com/identity/protocols/oauth2.
   b. For AWS S3 file s3_auth.json should contain region, Bucket name and AWS IAM creds with AmazonS3FullAccess.
   c. For IPFS adapter .env file should define CLOUD_URL that points out to the working IPFS node with open access. It can be started locally in docker see “Docker-compose configuration”.

Note: You can either try this branch as is (i.e. take the code from the branch, put it in your project folder, and start calling the methods that the code provides), or you can fork both the branch and master and merge yourself. If there are issues with using the branch directly, you can try and merge because by merging, any issues should come to light during the merge process and be easy to fix.
4. Once you have a node, you can include the JS SDK library into your project/program/application framework.

What is claimed is:

1. A method for interfacing a host software application with a blockchain network to conduct a blockchain transaction initiated through the host application, the method being performed by a processor executing computer program code contained in one or more software modules stored on one or more memory devices, the method comprising:
receiving action data representing a user action triggered in the host application during an authenticated session, the action data including authorization data for the user's access to the application;
converting the action data into blockchain intent payload data compatible with the blockchain network and representing a transaction to be performed on the blockchain network;
sending the blockchain intent payload data to a sponsor wallet service on the blockchain network for execution of the transaction;
receiving response data from the blockchain network representing a status of the execution of the transaction on the blockchain network; and
transmitting the response data to the application for use in responding to the user action.

2. The method of claim 1, further comprising evaluating, using stored policy rule data accessed by a sponsorship policy engine, the blockchain intent payload data to determine eligibility for performance of the transaction in the blockchain network, and wherein the step of sending the blockchain intent payload data to the sponsor wallet service is performed if the blockchain intent payload data is determined to be eligible.

3. The method of claim 2, further comprising, if the blockchain intent payload data is determined by the sponsorship policy engine not to be eligible for performance of the transaction in the blockchain network, notifying the host application that sponsorship is denied.

4. The method of claim 1, further comprising binding the user's authenticated session on the host application with a blockchain related service.

5. The method of claim 4, wherein binding comprises:
generating and sending to the blockchain related service a single-use nonce data value for the user's authenticated session, the nonce data value identifying the host application and user;
the blockchain related service constructing binding payload data and sending to a binding backend module data linking the user's authenticated application session and the blockchain related service; and
the binding backend module receiving and recording the binding payload data for use in verifying actions between the host application and the blockchain related service.

6. The method of claim 5, further comprising the blockchain related service being used to cryptographically sign the binding payload data using a private key and sending a public key associated with the private key to the binding backend module.

7. The method of claim 6, further comprising the binding backend module:
verifying the nonce data value is unused;
verifying that the signed payload transaction was validated and that the public key is valid; and
if these verifications pass, returning an application token for use in API calls between the host application and the blockchain service.

8. The method of claim 1, wherein the action data comprises a user request to access data that the host application has encrypted and stored on a secure storage device not part of the blockchain network.

9. The method of claim 8, wherein converting the action data comprises including in the blockchain intent payload data a payment transaction to be made in the blockchain for access to the encrypted data, and wherein transmitting the response data comprises transmitting an authorization by way of the host application to allow decryption of the encrypted data and release of the decrypted data to the user.

10. The method of claim 8, wherein an owner of the requested data allows access to the requested data to the user through a Hashed TimeLock Contract.

11. The method of claim 1, wherein execution of the transaction includes making a payment using one or more tokens or fractions thereof native to the blockchain network, further comprising:
the blockchain network issuing one or more new non-native tokens or fractions thereof;
computing, by an External Rate Service module, an adjustable exchange rate based on real-time and historical market data; and
determining, using the computed adjustable exchange rate, an amount of the one or more new non-native tokens or fractions thereof needed to obtain the amount of one or more native tokens or fractions thereof needed for the transaction; and
exchanging the determined amount of the new tokens or fractions thereof in return for payment of the transaction in one or more native tokens or fractions thereof.

12. The method of claim 1, further comprising:
receiving a request from the host application to create an account with the blockchain network, the request including account parameter data and registration data;
constructing account creation transaction data in a format native to the blockchain network, the transaction data comprising a plurality of parameters such as account name and registrar identification;
signing the account creation transaction data with credentials of the registrar; and
broadcasting the signed transaction data to the blockchain network.

13. A system for interfacing a host software application with a blockchain network to conduct a blockchain transaction initiated through the host application, the system comprising a plurality of layers of software modules represented by computer program code stored on one or more memory devices and executed by one or more processors, the system comprising:
a host application interface layer configured to receive action data representing a user action triggered in the host application during an authenticated session, the action data including authorization data for the user's access to the application;
an intent builder layer configured to convert the action data into blockchain intent payload data compatible with the blockchain network and representing a transaction to be performed on the blockchain network;
a sponsorship policy layer configured to send the blockchain intent payload data to a sponsor wallet service on the blockchain network for execution of the transaction;
a relay and orchestration layer configured to receive response data from the blockchain network representing a status of the execution of the transaction on the blockchain network and transmit the response data to the application for use in responding to the user action.

14. The system of claim 13, wherein the sponsorship policy layer is further configured to:
evaluate, using stored policy rule data, the blockchain intent payload data to determine eligibility for performance of the transaction in the blockchain network;
send the blockchain intent payload data to the sponsor wallet service if the blockchain intent payload data is determined to be eligible; and
notify the host application that sponsorship is denied if the blockchain intent payload data is determined not to be eligible for performance of the transaction in the blockchain network.

15. The system of claim 13, further comprising a binding layer configured to bind the user's authenticated session on the host application with the sponsor wallet service by:
generating and sending to the sponsor wallet service a single-use nonce data value for the user's authenticated session, the nonce data value identifying the host application and user;
receiving from the sponsor wallet service binding payload data linking the user's authenticated application session and the sponsor wallet service, the binding payload data cryptographically signed by the user using a private key;
receiving from the sponsor wallet service a public key associated with the private key; and
recording the binding payload data inclusive of the public key for use in verifying actions between the host application and sponsor wallet service.

16. The system of claim 15, wherein the binding layer is configured to record binding payload data by:
verifying the nonce data value is unused;
verifying that the signed payload transaction was validated and that the public key is valid; and
if these verifications pass, returning an application token for use in API calls between the host application and sponsor wallet service.

17. The system of claim 13, wherein the action data comprises a user request to access data that the host application has encrypted and stored on a secure storage device not part of the blockchain network, and wherein the intent builder layer is configured to convert the action data by including in the blockchain intent payload data a payment transaction to be made in the blockchain for access to the encrypted data.

18. The system of claim 13, wherein execution of the transaction includes making a payment using one or more tokens or fractions thereof native to the blockchain network, further comprising an External Rate Service module configured to:
compute an adjustable exchange rate based on real-time and historical market data; and
determine, using the computed adjustable exchange rate, an amount of one or more new non-native tokens or fractions thereof needed to obtain one or more native tokens or fractions thereof needed for the transaction, the one or more new non-native tokens having been issued by the blockchain network.

19. The system of claim 13, further comprising a service layer configured to create an account in the blockchain network for the host application by:
receiving a request from the host application to create an account with the blockchain network, the request including account parameter data and registration data;
constructing account creation transaction data in a format native to the blockchain network, the transaction data comprising a plurality of parameters such as account name and registrar identification;
signing the account creation transaction data with credentials of the registrar; and
broadcasting the signed transaction data to the blockchain network.

20. A non-transitory computer readable medium comprising instructions that, when executed by at least one processor on a computerized device, cause the at least one processor to execute a method for interfacing a host software application with a blockchain network to conduct a blockchain transaction initiated through the host application, the method comprising:
receiving action data representing a user action triggered in the host application during an authenticated session, the action data including authorization data for the user's access to the application;
converting the action data into blockchain intent payload data compatible with the blockchain network and representing a transaction to be performed on the blockchain network;
sending the blockchain intent payload data to a sponsor wallet service on the blockchain network for execution of the transaction;
receiving response data from the blockchain network representing a status of the execution of the transaction on the blockchain network; and
transmitting the response data to the application for use in responding to the user action.
